(19) United States
(12) Patent Application Publication
(10) Pub. No.: US 2026/0141644 A1
(43) Pub. Date: May 21, 2026

(54) SYSTEMS AND METHODS FOR ENHANCED VIRTUAL REALITY INTERACTIONS

(71) Applicant: State Farm Mutual Automobile Insurance Company, Bloomington, IL (US)

(72) Inventors: Jody A. Thoele, Bloomington, IL (US); Antonio Cunanan, Richardson, TX (US); Wesley Mao, Murphy, TX (US); David Herrera, Bloomington, IL (US)

(21) Appl. No.: 19/311,640

(22) Filed: Aug. 27, 2025

Related U.S. Application Data
(60) Provisional application No. 63/700,216, filed on Sep. 27, 2024.

(51) Int. Cl. G06T 19/00; G06N 20/00; G06T 13/40; H04L 51/02

(52) U.S. Cl. CPC G06T 19/00; G06N 20/00; G06T 13/40; H04L 51/02

(57) ABSTRACT

A computer system is described for conducting interactions of a simulated event for users in a virtual environment. The computer system includes a processor programmed to: (i) present the virtual environment including an item of a first user associated with a first user device; (ii) receive sensor data from one or more sensors associated with the first user device, the sensor data including data related to the item; (iii) select a simulated event involving the item; (iv) generate the simulated event involving the item and using the received sensor data for display within the virtual environment; and (v) cause the simulated event involving the item to be displayed within the virtual environment to the first user device and a second user device, wherein the first user and the second user visually experience the simulated event involving the item.

### CROSS-REFERENCE TO RELATED APPLICATIONS

This application claims the benefit of priority to U.S. Provisional Patent Application No. 63/700,216, filed Sep. 27, 2024, entitled “SYSTEMS AND METHODS FOR ENHANCED VIRTUAL REALITY INTERACTIONS,” the entire content and disclosure of which is hereby incorporated herein by reference in its entirety.

### FIELD OF DISCLOSURE

The present disclosure relates to enhanced virtual reality interactions and, more particularly, to network-based systems and methods for generating a virtual reality environment and facilitating an exchange of information through the virtual reality environment.

### BACKGROUND

The metaverse is designed for millions of users to interact with each other at any moment in time, as well as 24 hours a day, 7 days a week, all of the time. Since the metaverse may be a hosted virtual reality, individual users may desire to interact with other individuals through an avatar, both real and fictional. However, live individuals, either as an avatar or as a live person, may only be able to interact with one or a few users at a time and may not be available all of the time.

In the metaverse, it may also be desirable to increase trust and confidence of the user in the individuals interacting with the user within the metaverse, and for the individuals to appropriately respond to any questions, statements, gestures, or an emotional state of the user displayed within the metaverse. Conventional techniques may include additional inefficiencies, encumbrances, ineffectiveness, and/or other drawbacks as well.

### BRIEF SUMMARY

The present embodiments may relate to, inter alia, computer systems and computer-based methods for enhanced virtual reality interactions. In an exemplary embodiment, the systems and methods may generate a VR (Virtual Reality) environment that includes (i) one or more avatars, and/or (ii) one or more virtual locations that may be visited by a user avatar controlled by a user with a user device (e.g., an AR (Augmented Reality) or VR headset and/or other AR or VR system). These virtual locations may include places of business, such as insurance agencies, or other locations, having real-world counterparts, and may be occupied by user avatars (e.g., if the agent is available live) and/or avatars associated with a replica persona of the agent (e.g., if the agent is not available live).

Further, by visiting the locations virtually, the user may purchase products or obtain information about the business, for example, by viewing overlays or aspects of the VR environment itself (e.g., virtual signage or documents included in the VR environment) and/or by interacting with an avatar associated with the corresponding agent (e.g., by asking questions and receiving responses from the agent or the agent's virtual replicant). Further, the present embodiments described herein may relate to systems and methods for simulating an event involving an asset in a virtual environment. The user computing device may transmit an event selection corresponding to an asset in the virtual environment. The event selection may include an accident or type of damage the user may want to simulate with respect to the asset within the virtual environment so that the user is better able to see and understand the event or damage that may occur. The event simulation within the virtual environment may be used, for example, to virtually inspect the asset, for example, in a pre-event condition, during the event simulation, and/or post-event simulation. In addition, an insurance agent may use the event simulation to determine risks to an asset (e.g., an insured asset) and determine mitigation strategies for the risk associated with the asset. This analysis including the mitigation strategies many then be presented to the user within the virtual environment.

In one aspect, a computer system for conducting interactions of a simulated event for a plurality of users in a virtual environment is provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computer system may include at least one processor and/or associated transceiver in communication with at least one memory device and in communication with one or more user computer devices. The at least one processor may be programmed to: (i) communicate with the one or more user computer devices to cause the one or more user computer devices to present the virtual environment including at least one item of a first user associated with a first user device of the one or more user computer devices; (ii) receive sensor data from one or more sensors associated with the first user device, the sensor data including data related to the at least one item; (iii) select a simulated event involving the at least one item based upon an input from the one or more user computer devices; (iv) generate the simulated event involving the at least one item and using the received sensor data for display within the virtual environment; and (v) cause the simulated event involving the at least one item to be displayed within the virtual environment to the first user using the first user device and at least a second user associated with a second user device of the one or more user computer devices, wherein the first user and the second user visually experience the simulated event involving the at least item via the respective first user device and the second user device. The computer system may have additional, less, or alternate functionality, including that discussed elsewhere herein.

In another aspect, a computer-implemented method for conducting interactions of a simulated event for a plurality of users in a virtual environment is provided. The computer-implemented method may be implemented using one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computer-implemented method may be implemented using at least one processor and/or associated transceiver in communication with at least one memory device and in communication with one or more user devices. The computer-implemented method may include: (i) communicating, via the at least one processor, with the one or more user computer devices to cause the one or more user computer devices to present the virtual environment including at least one item of a first user associated with a first user device of the one or more user computer devices; (ii) receiving, via the at least one processor, sensor data from one or more sensors associated with the first user device, the sensor data including data related to the at least one item; (iii) selecting, via the at least one processor, a simulated event involving the at least one item based upon an input from the one or more user computer devices; (iv) generating, via the at least one processor, the simulated event involving the at least one item and using the received sensor data for display within the virtual environment; and (v) displaying, via the at least one processor, the simulated event involving the at least one item to be displayed within the virtual environment to the first user using the first user device and at least a second user associated with a second user device of the one or more user computer devices, wherein the first user and the second user visually experience the simulated event involving the at least one item via the respective first user device and the second user device. The computer-implemented method may include additional, less, or alternate functionality, including that discussed elsewhere herein.

In yet another aspect, at least one non-transitory computer-readable media having computer-executable instructions embodied thereon may be provided. The computer-executable instructions may be executed by a computer system including at least one local or remote processor and/or associated transceivers in communication with at least one local or remote memory device and in communication with a user device associated with a user and with an agent interface associated with an agent. The computer-executable instructions may direct or cause the at least one processor to: (i) communicate with the one or more user computer devices to cause the one or more user computer devices to present a virtual environment including at least one item of a first user associated with a first user device of the one or more user computer devices; (ii) receive sensor data from one or more sensors associated with the first user device, the sensor data including data related to the at least one item; (iii) select a simulated event involving the at least one item based upon an input from the one or more user computer devices; (iv) generate the simulated event involving the at least one item and using the received sensor data for display within the virtual environment; and (v) cause the simulated event involving the at least one item to be displayed within the virtual environment to the first user using the first user device and at least a second user associated with a second user device of the one or more user computer devices, wherein the first user and the second user visually experience the simulated event involving the at least one item via the respective first user device and the second user device. The computer-executable instructions may have additional, less, or alternate functionality, including that discussed elsewhere herein.

In another aspect, a computer system for generating a virtual reality replicant persona for interaction with at least one user may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computer system may include at least one processor and/or associated transceiver in communication with at least one memory device and in communication with a user device associated with a user and with an agent interface associated with an agent. The at least one processor may be programmed to: (i) communicate with the one or more user computer devices to cause the one or more user computer devices to present a virtual environment including at least one item or asset of a first user associated with a first user device; (ii) receive sensor data from the first user device of the one or more user computer devices; (iii) select a simulated event involving the at least one item or asset based upon an input from the one or more user computer devices; (iv) generate the simulated event involving the at least one item or asset and using the received sensor data for display within the virtual environment; and/or (v) cause the simulated event involving the at least one item or asset to be displayed within the virtual environment to the first user using the first user device and at least a second user associated with a second user device of the one or more user computer devices, wherein the first user and the second user visually experience the simulated event via the respective first user device and the second user device. The computer system may have additional, less, or alternate functionality, including that discussed elsewhere herein.

In another aspect, a computer-implemented method for generating a virtual reality replicant persona for interaction with at least one user may be provided. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality (XR) glasses or headsets, voice bots or chatbots, ChatGPT or ChatGPT-based bots, and/or other electronic or electrical components, which may be in wired or wireless communication with one another. For example, in one instance, the computer-implemented method may be implemented by a computer system including at least one processor and/or associated transceiver in communication with at least one memory device and in communication with a user device associated with a user and with an agent interface associated with an agent. The method may include: (i) communicating, via the one or more processors, with the one or more user computer devices to cause the one or more user computer devices to present the virtual environment including at least one item or asset of a first user associated with a first user device; (ii) receiving, via the one or more processors, sensor data from one or more sensors associated with the first user device of the one or more user computer devices; (iii) selecting, via the one or more processors, a simulated event involving the at least one item or asset based upon an input from the one or more user computer devices; (iv) generating, via one or more processors, the simulated event involving the at least one item or asset and using the received sensor data for display within the virtual environment; and/or (v) presenting, via the one or more processors, within the virtual environment to a first user using the first user device, an event simulation corresponding to the item or asset in the virtual environment. The method may include additional, less, or alternate actions, including those discussed elsewhere herein.

In yet another aspect, at least one non-transitory computer-readable media having computer-executable instructions embodied thereon may be provided. The computer-executable instructions may be executed by a computer system including at least one local or remote processor and/or associated transceivers in communication with at least one local or remote memory device and in communication with a user device associated with a user and with an agent interface associated with an agent. The computer-executable instructions may direct or cause the at least one processor to: (i) communicate with the one or more user computer devices to cause the one or more user computer devices to present the virtual environment including at least one item or asset of a first user associated with a first user device; (ii) receive sensor data from the first user device of the one or more user computer devices; (iii) select a simulated event involving the at least one item or asset based upon an input from the one or more user computer devices; (iv) generate the simulated event involving the at least one item or asset and using the received sensor data for display within the virtual environment; and/or (v) cause the simulated event involving the at least one item or asset to be displayed within the virtual environment to the first user using the first user device and at least a second user associated with a second user device of the one or more user computer devices, wherein the first user and the second user visually experience the simulated event via the respective first user device and the second user device. The computer-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the computer systems and computer-based methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed. However, it should be understood that the present embodiments are not limited to the precise arrangements and/or instrumentalities shown herein.

FIG. 1 illustrates a schematic diagram of an exemplary event simulation computing system for interaction with at least one user in a virtual environment according to an exemplary embodiment of the present disclosure.

FIG. 2 illustrates a simplified block diagram of an exemplary computer system for interaction with at least one user in a virtual environment according to an exemplary embodiment of the present disclosure.

FIG. 3 illustrates an exemplary configuration of a client computer according to an exemplary embodiment of the present disclosure.

FIG. 4 illustrates an exemplary configuration of a server computing device according to an exemplary embodiment of the present disclosure.

FIG. 5 illustrates an exemplary view of an event simulation provided by the computer system shown in FIG. 1.

FIG. 6A illustrates a flow chart of an exemplary computer-implemented process for interaction with at least one user in a virtual environment according to an exemplary embodiment of the present disclosure.

FIG. 6B is a continuation of the flow chart illustrated in FIG. 5A.

FIG. 7 illustrates a flow chart of an exemplary computer-implemented process for generating an avatar for an agent or other individual according to an exemplary embodiment of the present disclosure.

FIG. 8 depicts a flow chart of an exemplary computer-implemented process for providing a secure data exchange in a virtual environment such as the virtual environment described as an exemplary embodiment of the present disclosure.

FIG. 9 depicts a flow chart of an exemplary computer-implemented process for providing an event simulation in the virtual environment described as an exemplary embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

As described herein, a replicant persona may be an artificial intelligence (AI) driven digital recreation of an individual, such as, but not limited to, agents or representatives associated with a business and/or other individuals. These replicant personas may include real and fictional human or non-human individuals. The replicant persona may be trained to simulate a personality of an individual including replicating the traits of the individual including, but not limited to, their mannerisms, appearance, personality, historical and conversational talking points of an actual, real-life person.

Also, as described herein, an avatar may be an audio and/or visual representation of the individual being controlled by the replicant persona. In the exemplary embodiment, an avatar may be used to interact with virtual reality users, such as in a virtual reality environment. In some embodiments, there may be multiple avatars for the same replicant persona. For example, multiple avatars for an individual may be in multiple locations in the virtual reality environment.

In some exemplary embodiments, an avatar may be connected to or controlled by the replicant persona, where the replicant persona controls the actions and reactions of the individual avatars. For example, if a question is asked of the avatar, the question may be routed to the replicant persona, which formulates a response and transmits the response to the avatar. In some embodiments, a single replicant persona may control multiple avatars simultaneously. In some examples, an avatar may be performing as a virtual agent to sell an insurance policy and/or other products, receive and/or process insurance claims, and/or provide information and/or answer general insurance-related questions within the metaverse. In other words, an avatar associated with a replicant persona may be a virtual agent avatar and may explain an insurance policy or insurance coverage and/or other products to a user directly, or via a user avatar of a user described below.

For the purposes of this discussion, a user avatar may be an audio and/or visual representation of a user that is directly controlled by that user within a virtual reality environment. The user avatar may be controlled via the user computer device as the user is logged into the virtual reality environment. In some embodiments, the user avatar may be a direct representation of the user. In other embodiments, the user avatar is anything that the user wishes to be within the virtual reality embodiment (such as animal or imaginary creature, e.g., unicorn, dragon, flying rabbit, etc.). The user may be able to modify their user avatar to change its appearance, such as by changing the appearance, clothing, hairstyle, skin or fur color, size, demeanor, and other attributes of the user avatar. In some embodiments, a user avatar may be associated with an account of the user. In some of these embodiments, the user may have more than one account and therefore multiple user avatars. In some further embodiments, the user may have multiple user avatars associated with their account and use different ones at different times.

As used herein, “VR environment” or “virtual environment” refers to a digital or virtual environment experienced by or displayed to a user through a VR (virtual reality) computing device. In other words, “VR environment” refers to the VR view and functionality experienced by a user through a VR enabled computing device. Conversely, any virtual or digital environment displayed to a user through a VR computing device may be considered a VR environment.

As used herein, “AR environment” refers to a digital or virtual environment overlaid on a real-world environment and experienced by a user through a VR/AR (Augmented Reality) computing device. In other words, “AR environment” refers to the AR display and functionality experienced by a user through an AR enabled computing device. Mixed or eXtended reality (XR) devices may also be used for input and/or output.

In some embodiments, the VR and/or AR may allow for haptic responses to allow the user to feel an interaction with an object. The haptic response may be provided through the use of gloves or other feedback devices. In one embodiment, the haptic response may allow the user to feel the texture of the 3-D object and/or the weight of the 3-D object. For example, the user may shake the avatar's hand or receive a virtual object from the avatar, and the user may be able to feel the handshake, or the object being handed to the avatar. In other embodiments, the VR and/or AR systems may allow the user to experience other sensory outputs such as smell, taste, hearing, sight, sound, touch, and/or balance.

The present embodiments may relate to, inter alia, systems and methods for enhanced virtual reality interactions. In the exemplary embodiment, the systems and methods may generate a VR environment that includes (1) one or more avatars, and/or (2) one or more virtual locations that may be visited by a user avatar controlled by a user with a user device (e.g., an AR or VR headset and/or other AR or VR system). These virtual locations may include places of business, such as insurance agencies, and/or other locations including one or assets of interest, having real-world counterparts, and may be occupied by user avatars (e.g., if the agent is available live) and/or avatars associated with a replica persona of the agent (e.g., if the agent is not available live). In some cases, a virtual location is based upon an actual geographic location. By visiting the locations virtually, the user may purchase products or obtain information about the business or various products/services, for example, by viewing overlays or aspects of the VR environment itself (e.g., virtual signage or documents included in the VR environment) and/or by interacting with an avatar associated with the corresponding agent (e.g., by asking questions and receiving responses from the agent or the agent's virtual replicant). Or may inspect the one or more assets in the VR environment in various conditions.

For example, by visiting and interviewing agents in a virtual setting, the user does not need to physically travel to interact with different agents, therefore making it easier for users in remote locations to interact with one or more agents, and also making it easier for users identify an agent having attributes (e.g., background, affinity, demographics, technical skills, language skills, experience, education, hobbies, etc.) compatible with or considered desirable by the user. For example, by visiting one or more virtual locations, users may get to know different agents by interviewing and/or viewing information (e.g., introductory videos) relating to the agent.

In addition, the computer systems and computer-implemented methods described herein may be configured to provide an event simulation involving an asset or item of the user. More specifically, the system may be configured to provide a simulation of the effect(s) of various natural phenomena on a subject property to a user interface of a user computing device before, during, and after the event. In various embodiments, the system may utilize sensor data, historical data, and event data associated with an item or asset as input to a model to simulate the event. The model may process the sensor data, the historical data, and the item data to generate an event simulation that includes the pre-event condition of the item, the condition of the item during the event, and the post-event condition of the item. The model may utilize the sensor data, the historical data, and the event data to generate the pre-event condition of the item based upon sensor data corresponding to a real-world post-event condition of an item. In other embodiments, the system may generate a post-event condition of the item based upon the sensor data, the historical data, and the event data.

In other words, the systems and methods described herein are configured to conduct interactions of a simulated event for a plurality of users in a virtual environment. The systems and methods may include communicating with the one or more user computer devices to cause the one or more user computer devices to present the virtual environment including the at least one item of a first user associated with a first user device of the one or more user computer devices. Thus, the one or more items at issue are displayed within a virtual environment. The item will look like it does in the real world in the virtual environment. The systems and methods may further include receiving sensor data from one or more sensors associated with the first user device wherein the sensor data includes data related to the at least one item, and selecting a simulated event involving the at least one item based upon an input from the one or more user computer devices. For example, the item may be the user's car, and the senor data may include a variety of data points about the car including a photo or video of the car. The system may then create a virtual image of the car and display it within the virtual environment. The selected simulated event may be a flood near the home of the user where the car is typically parked. The system may then create the simulated flood event and display how the flood may or may not impact the car when it is parked near the home of the user. Different parameters could be inputted within the event model to simulate the flood event or different flood events near the home of the user and show how they may impact the parked car.

The systems and methods may further include generating the simulated event involving the at least one item and using the received sensor data for display within the virtual environment, and causing the simulated event involving the at least one item to be displayed within the virtual environment to the first user using the first user device and at least a second user associated with a second user device of the one or more user computer devices, wherein the first user and the second user visually experience the simulated event involving the at least item via the respective first user device and the second user device.

In the example embodiment, the system and method may further include an event model (AI/ML) that is trained to generate the simulated event based on (i) the sensor data including image data of the at least one item, and (ii) input from the one or more user computer devices including a geographic location of the at least one item at a time when the simulated event occurs to the trained first event model to generate one or more model outputs for display within the virtual environment including a display of the first simulated event and an impact of the first simulated event on the at least one item.

For example, the item may be a property that may be located in an area prone to heavy rainfall and/or flooding. Accordingly, upon selection of a flooding event selection, the user device event simulation may be generated by an insurance underwriter or a homeowner interested in the risk to property for flood damage (or other water-related damage or loss). Using traditional methods, the insurance underwriter or homeowner (“user”) may have had to consult various two-dimensional peril and/or topographical maps, as well as historical floodplain data, to attempt to ascertain the level of risk to property due to a flood or other damage from water source.

However, using the system and method described herein, an event simulation may be generated using AI tools to indicate at least one effect on the property due to the proposed event (e.g., a rainfall having the user-input variables described above). The event simulation may include the condition of the item or asset during the event and the condition of the item or asset after the event. An effect may include no damage, some damage, total property loss, partial property loss, land damage, and/or various other potential effects, which may be characterized using a loss estimate. The simulation may include various situation information determined by the conditions expressed by user-input variables. In various embodiments the system includes an output sensor device connected to the user device that allows the user to experience the event within the virtual environment. For instance, the output sensor provides visual, haptic, audio, and olfactory data to the user based upon the event simulation. The output sensor allows increases the user's immersion into the virtual environment while also providing them with a more accurate simulation of the event.

The event simulation may further include a loss estimate, which communicates to the user the potential for loss or damage to the item based upon the event selection. The loss estimate may be generated by the system using various internal underwriting information associated with the item, including value of the item and/or other specifications. For example, if an event simulation showed water levels that would damage a basement and a detached structure associated with the insured item, the value (or percentage of total value) of those structures may be displayed to the user in the virtual environment, relative to the estimated severity and duration of the disaster (e.g., water levels high enough to flood a basement would not necessarily result in a total loss, but may result in a total loss for a detached structure that is submerged or washed away). In this way, the event simulation may quantify the risk of an event to the user and identify the recommendations for mitigation practices to align insurance coverage for the asset to risks.

Additionally, data provided by the user or agent may be recorded and stored in a database, so that the data may be retrieved seamlessly for future interactions within the VR environment and for traditional interactions outside of the VR environment. For example, records of interactions within the virtual environment may be used to process any transactions that may have occurred within the virtual environment.

The system may further provide for a secure exchange of documents and/or other data using a virtual file cabinet mechanism. The virtual file cabinet may enable a user to securely store documents and to authorize other users to access the documents. For example, a user may, through input (e.g., within the virtual environment, a mobile app, and/or web page) designate documents (e.g., insurance policy documents, insurance cards, insurance claim files, financial or other accounts, and/or documents and/or other data relating to insurance claims) to be stored in the virtual file cabinet, or the documents may automatically be stored in association with the virtual file cabinet in response to certain events (e.g., purchase or renewal of an insurance policy and/or filing of an insurance claim). The user may also designate other users (e.g., agents, other individuals involved in an insurance claim) to access any of these stored documents, or the system may determine which individuals to authorize for access. These authorized users may than retrieve, view, and/or trigger a download of these documents, for example, by accessing the virtual file cabinet within the virtual environment. In embodiments in which the virtual file cabinet includes insurance-related documents, this access to the virtual file cabinet may enable the authorized users to access those documents and quickly determine coverage in real time in case of an event or other insurance-related event. It should be noted that access to the virtual file cabinet may further include access to certain documents included within the file cabinet. In other words, a blanket or broad access may be given to a certain user by the authorized user so that that the broad access user is able to see and access all documents included within the virtual file cabinet. In another case, a user may be given limited or targeted access to a specific set of documents included in the virtual file cabinet, and that limited access user would only be able to see and access those documents.

The computer systems and computer-implemented methods described herein may further provide for a real time event support in the virtual environment. The system may receive sensor data from the user computer devices (e.g., data captured by smart glasses) which may be used to determine if an event (e.g., a vehicular collision or other incident resulting in injury and/or property damage) has occurred. In response to detecting an event and/or receiving input from the user (e.g., as a voice command) that an event has occurred, the system may prompt the user to interact with a live agent and/or replicant persona in the virtual environment as described above.

The system may provide guidance and/or instructions to the user via the user device, for example, as prompts displayed within the virtual environment and/or instructions provided by an agent avatar. These prompts may include text or speech (e.g., speech associated with the virtual avatars described above). The prompts may include questions verifying that the user is not injured or to provide information about what has occurred. For example, the prompts may instruct the user to take pictures and/or ask questions to others present at the scene of the event. The user device may also passively collect data, such as image and/or audio data, in response to the event being detected.

This collected information may be used to determine if additional resources, such as emergency personnel or insurance personnel, need to be contacted, and automatically initiate such contact (e.g., by initiating an emergency “9-1-1” call and/or presenting an agent avatar within the virtual environment as described above). The collected information may further be used to generate digital twins, simulations, and/or visual reconstructions of the event, which may be used to determine an extent of damage or injury that has occurred and the cause of the event, such as vehicle or vehicle system or component failure (such as in the case of autonomous vehicles or smart vehicle automated systems) and/or identify those innocent and not to blame for the event. In various embodiments, these reconstructions may be viewed within the virtual environment.

### Providing User Interactions in a Virtual Environment

In the exemplary embodiment, the system may communicate with the user device to cause the user device to present the VR environment. The system may provide video data, audio data, or other data (e.g., haptic feedback data, olfactory data, or other sensory data that may be presented to the user by the user device). The system may receive user input data such as live audio data, live video data, or live motion data from the user device, and based upon this received user input data, the system may continually update the VR environment. For example, the system may respond to motion, voice commands or other speech, and/or other input (e.g., facial expressions) of the user. In some embodiments, if the system determines that the user is visiting a location within the VR environment based upon the input data, an agent or other individual associated with the location may receive a notification.

In the exemplary embodiment, the system may be configured to receive sensor data from one or more sensors associated with the user computer devices. For example, at least some of the user computing device may include cameras, microphones, motion sensors (e.g., accelerometers and/or gyroscopes), location sensors (e.g., GPS), radar, and/or lidar. User computer devices may also include biometric sensors, including for example and without limitation, heart rate sensors, oxygen, or CO2 sensors, a stress sensor (e.g., continuous electrodermal activity (cEDA) sensors), temperature sensors, blood pressure sensors, and/or sweat sensor (e.g., epidermal optic sensors). The user computer devices may include any other types of sensors. This data may be received (e.g., continuously, or periodically) prior to, during, and following an event. As described in further detail below, this senor data may be used by the system to determine when an event has occurred and to gather information about the nature, scene, context, and results of the event.

In the exemplary embodiment, the system may generate a proposed response to a user based upon received user input data. User input that indicates a response may be required may include questions input by the user (e.g., as voice or text) or other actions by the user. For example, if the user is not talking but has a confused facial expression, the system may determine that information or some other assistance should be offered to the user. The proposed response may include information to provide the user (e.g., specific language to speak to the user and/or documents to provide to the user), motions or gestures to performed by the agent avatar, or other actions.

In various embodiments, these responses may include actions outside of the VR environment, such as sending emails, phone messages, and/or text messages to the user. For example, if the user agrees to a purchase within the VR environment, the system may transmit documents for the user to sign or forms for the user to submit payment information as an email and/or web link. In some embodiments, transmission of these documents may be triggered by analogous actions in the VR environment, such as by dropping a document into a virtual mailbox. In some embodiments, these responses may include real-time binding offers or quotes (e.g., insurance quotes), to which the user may accept within the VR environment. These may be generated based upon data provided by the user within the VR environment and/or other retrieved data about the user (e.g., from a user profile and/or other web sources or databases accessible by the system). Any input from the user or agent may be recorded by the system to enable such transactions to be processed and referred back to in the future.

In certain embodiments, when the system generates a proposed response, the system may determine whether an agent is present at an agent interface (e.g., a computer and/or an VR or AR headset through which the agent may control a respective avatar). For example, the system may determine whether the agent is logged in and/or has made any input through the user interface (e.g., speech, motion, keystrokes, etc.) within a threshold period of time. When the agent is present at the agent interface, the system may cause the agent interface to display a recommendation including the proposed response. For example, the recommendation may be displayed as an overlay within the VR environment visible to the agent, although not visible to the user or others accessing the VR environment.

In these cases, the recommendations may direct the agent on how to respond to questions, statements, gestures, facial expressions, and/or other actions made by the user. For example, if the system determines the user is becoming confused during an interaction with the agent, the generated recommendations may direct the agent to slow down and/or offer additional explanation. These recommendations may be generated using one or more chatbots and/or using AI programs such as ChatGPT. In some embodiments, if the user and agent speak different languages, the system may provide translation in real time.

In various embodiments, when the agent is not present at the agent interface, the system may cause at least one avatar associated with the agent to perform the proposed response based upon a replicant persona associated with the agent. In such cases, the avatar may replicate the traits of the agent including, but not limited to, the mannerisms, appearance, personality, historical and conversational talking points. Actions or responses of the replicant persona may be generated using one or more chatbots and/or using AI programs such as ChatGPT. Accordingly, the avatar may act as a user interface for the business when the agent is not present or unavailable, with the avatar interacting with users to provide information about and to collect information for the business.

For instance, a replicant persona for an agent or other representative for a business may be created and stored. When a user in a virtual reality environment walks into the virtual reality representation of the business, the user is greeted by an avatar of the agent that may answer questions and potentially handle the user's request(s). In various embodiments, a new avatar (e.g., each representing the agent) may be generated to interact with each user. These could be multiple avatars each connected to different personas or multiple avatars with the same persona. Therefore, multiple users could be interacting with their own version of the avatar of the agent, simultaneously. This allows the business to provide a personal, singular engagement.

In a further example, an avatar generated to interact with a user may be trained to interact with the user within the metaverse in accordance with certain traits of the agent learned through virtual or actual interaction with the user. In one example, the traits of the agent may include the agent's body language, the agent's speaking accent and/or dialect observed from an initial interaction (real or virtual) with the agent for a specific training period (e.g., initial 5 minutes or 10 minutes). Additionally, or alternatively, the traits of the agent may be retrieved from a database in which the agent's profile and the traits of the agent are stored.

In various embodiments, the avatar may be interacting with the user to sell a new product or service (e.g., insurance products) for an item or asset of the user, or the avatar may be interacting with the user for a claim submitted by the user for an event, a loss of a vehicle, or damage to the user's home, and so on. Accordingly, the avatar may be trained to show empathy, excitement, joy, kindness, or some other emotion that is appropriate with the cause of the interaction with the user. Additionally, or alternatively, certain traits or mannerisms of the avatar representing the agent, which may help to increase the user's confidence and trust in the product and/or service being marketed or sold by the avatar, may be used to train the avatar to incorporate those traits and/or mannerisms into the avatar during interaction with the user. In some cases, those traits or mannerisms incorporated into the agent's avatar may include similar traits and mannerism expressed by the user or the user's avatar.

In various embodiments, the avatar may initially be controlled by a live agent, for example, to respond to or greet the user, and/or to interact with the user to provide answers or information to the user. However, based upon the monitoring of the virtual interaction between the avatar being controlled by the real agent and the user, if it is determined that the interaction is not meeting a specific criterion, for example, the real agent's interactions with the user are not generating the desired responses or feedback from the user, the avatar may then become controlled by an artificial intelligence (AI) model or a machine-learning model to meet the specific criterion. For example, the real agent may be having a bad day, and, therefore, may be unable to show an appropriate level of empathy to the user while interacting with the user. Upon detecting such a condition or feedback from the user, the system may take control of the avatar via the AI model or the ML model to adjust the level of empathy being presented to the user. Conversely, if is determined that a computer-controlled avatar is not meeting a specific criterion, the system may alert a live agent to take control of the avatar.

In some examples, based upon an agent profile of the agent or historical interactions with the agent, if it is determined that the agent has a specific accent or dialect associated with a specific geographic location, the avatar may interact with the user using the specific accent or dialect. If it is learned that the agent frequently uses jokes, or one-liners while interacting, the avatar may be trained to use similar behavior while interacting with the user, which is likely to increase a comfort level of the user while interacting with the agent's avatar.

In addition, using a microphone and/or a camera, the agent's facial gestures, hand gestures, body language, and so on, may be recorded (e.g., while the agent is controlling the avatar live) and used for training the avatar to interact with the user in a specific way. An artificial intelligence (AI) model or a machine-learning (ML) model may be used to train the avatar to identify which traits of the agent are beneficial to mimic or reproduce to increase the user's trust and confidence, and/or which traits of the agent may not be used by the avatar. The AI or ML model may also be used to train the avatar to use empathy corresponding to the cause of interaction with the avatar. For example, if the user has bought a new home or vehicle and is interacting with the avatar to purchase a new insurance policy, the avatar may use a happy or celebration tone while interacting with the user. Similarly, if the user is interacting with the avatar to report a damage or injury claim, the avatar may use a more supportive tone while interacting with the user.

The replicant persona, based upon which the avatar may be controlled, may be generated using one or more of Deep/Machine Learning (ML), Natural Language Processing (NLP), Voice Intelligence, and Artificial Intelligence (AI) to digitally replicate physical features and personality traits, mannerisms, voices, conversational style, quirks, interactions, facial expressions, hand gestures and/or other visible or audible mannerisms, and historical data and roles of the agent. The replicant persona is then used to generate one or more avatars to create unique and personalized experiences for users in a virtual reality or augmented reality space.

Data used to develop this replicant persona may include, but is not limited to, all available interactions from movies, videos, social media posts, interviews, recordings, images, scripts, other sources where a person's (e.g., an agent's) true personality and style could ultimately be captured, and/or current or previous interactions with the user. These data points could then be synthesized by deep/machine learning and cognitive computing and AI Voice subfields to accurately represent the agent and how they might respond given certain inputs and scenarios while interacting with the user.

The replicant persona may be used to generate individual avatars for different interactions. In some further embodiments, the individual avatar may be loaded with or have access to information about the individual user that the avatar is interacting with. For example, the avatar may know the user's name and call them by name directly. In a business interaction, the avatar may know additional information about the user, up to and including account details and/or other private or personally identifiable information.

In some embodiments, where the person (e.g., agent) to be represented by the avatar is available, the system may use a 3-D indexing tool to scan the agent. The 3-D indexing tool may scan and capture the physical essence of the agent including, but not limited to physical attributes, tattoos, hair style, make-up, clothing, and other interesting aspects of the agent to use with an avatar that interacts with the user.

In some examples, a user may use his/her user avatar to interact with the virtual reality environment, including interacting with other user avatars in the environment. While a user avatar represents the individual user on a one-to-one basis, a replicant persona may have multiple avatars executing simultaneously in different areas of the virtual reality. For example, a first user may be in a virtual room with a first avatar of the replicant persona, while a second user is in a separate virtual room with a second avatar of the same replicant persona. The first user and the second user are able to separately and simultaneously interact with their own avatar of the replicant person.

The use of virtual reality (VR) and augmented reality (AR) for interacting with 3D avatars provides a new interface for interacting in new ways. VR and AR systems allow a user to interact with a 3D virtual environment in a new way compared to traditional interactions using a two-dimensional (2-D) display. In VR, a user may be immersed in a virtual environment (e.g., using a VR headset). In other words, a VR device displays images, sounds, etc. to the user in a way that mimics how a user receives sensory stimuli in the real world. In AR, the user may be provided with digital data that overlays objects or environments in the real world (such as via AR glasses). AR devices may use a camera or other input to determine the objects in a user's line of sight and present additional digital data that compliments the real-world environment.

Examples of VR environments may include, but are not limited to, Minecraft® (Minecraft is a registered trademark of Microsoft Corporation, Redmond, Washington), Metaverse, and Second Life® (Second Life is a registered trademark of Linden Lab of San Francisco, CA). These VR environments allow the user to interact with and modify said environments using VR tools, such as by building and creating content including structures and objects.

As described in further detail herein, VR and AR technologies may be utilized to more effectively interact with avatars, such as described herein. In one embodiment, a user interacts with an avatar using VR. Specifically, the user navigates a virtual environment, applying bounding frames to objects, labeling objects, rotating views, and traversing areas of the virtual environment using a VR device. The user also interacts with individual avatars in the virtual environment. These avatars may be other users with their user avatars or avatars controlled by replicant personas as described herein. In other words, the user is immersed in a virtual environment and interacts with the virtual environment through the VR device in order to interact with and/or view 3D objects and avatars. In one embodiment, the virtual environment is a recreation and/or representation of a place of business and the user interacts with avatars in the place of business to conduct transactions with the business.

In another embodiment, a user views a real-world environment, and an AR device displays virtual content overlaying the real-world environment. Specifically, if the user is in a geographic location associated with the geographic location of an avatar, the AR device may overlay the real-world environment with the avatar from the 3D digital environment, allowing the user to interact with the digital environment and digital objects. For example, the user may be in a place of business, and the user may receive information about the business or its products as an overlay.

### Providing Secure Data Exchange in a Virtual Environment

In the exemplary embodiment, the system may provide for a secure exchange of documents and/or other data using a virtual file cabinet mechanism. The virtual file cabinet may enable a user to securely store documents and to authorize other users to access the documents. For example, a user may, through input (e.g., within the virtual environment, a mobile app, and/or web page) designate documents (e.g., insurance policy documents, insurance cards, and/or documents and/or other data relating to insurance claims) to be stored in the virtual file cabinet, or the documents may automatically be stored in association with the virtual file cabinet in response to certain events (e.g., purchase or renewal of an insurance policy and/or filing of an insurance claim). The user may also designate other users (e.g., agents, other individuals involved in an insurance claim) to access any of these stored documents, or the system may determine which individuals to authorize access to certain documents stored within the virtual file cabinet. These authorized users may than retrieve, view, and/or trigger a download of these documents, for example, by accessing the virtual file cabinet within the virtual environment. In embodiments in which the virtual file cabinet includes insurance-related documents, such access may enable authorized users to quickly access these documents and determine insurance coverage in real time in case of an event or other insurance-related event.

In the exemplary embodiment, the system may be configured to communicate with one or more user computer devices to cause those user computer devices to present the virtual environment to include at least one virtual file cabinet associated with a first user. In some embodiments, the virtual file cabinet may appear similar to an actual file cabinet or any other item (e.g., a safe or a file cabinet) users would likely understand to indicate a secure place to store documents. Alternatively, the virtual file cabinet may appear as any other type of item, point, or node within the virtual environment labeled as such (e.g., an icon or button). As described above, each user may have a corresponding user avatar, which may interact with the virtual file cabinet within the virtual environment analogously to how a person may interact with a file cabinet in real life (e.g., opening or closing and/or depositing or withdrawing documents). As described in further detail below, access to and/or the appearance of the file cabinet to a particular user may be controlled based upon whether the particular user is authorized to access any documents stored in the virtual file cabinet. Within the virtual environment, the virtual file cabinet may include and/or be labeled with text or indicators providing information about the virtual file cabinet (e.g., which user is associated with the file cabinet, a relationship between the viewer and the user is associated with the file cabinet, and/or whether the viewer has access to any documents in the virtual file cabinet). For example, the file cabinet may include a lock that requires a combination or code to be entered to allow a user to access documents included within the file cabinet. A different code may be tied to the different documents included with in the virtual file cabinet such that when a code is entered only the documents linked to that code are shown and are accessible by that user.

In the exemplary embodiment, the system may be configured to store one or more documents in the memory in association with the virtual file cabinet. For example, the user may designate documents to store in association with the virtual file cabinet or the system may automatically determine and store or suggest storing, documents in association with the virtual file cabinet. In various embodiments, the user may input instructions at a mobile device via a mobile application to store documents in associated with the at least one virtual file cabinet. The system may then store the one or more documents in association with the at least one virtual file cabinet in response to receiving the instruction. In some embodiments, the user may generate user input data (e.g., by making corresponding movements and gestures) with the user device that indicates an intention to store the one or more documents in association with the virtual file cabinet (e.g., dragging and placing, or selecting from a menu). The system may then store the one or more documents in association with the virtual file cabinet in response to receiving this user input data. In some embodiments, the system may automatically identify documents to store. For example, the system may identify any insurance policy document, insurance cards, and/or insurance claim documents that are associated with the user, and may automatically store the documents or generate recommendations for the user to store the documents in the virtual file cabinet.

In the exemplary embodiment, the system may be configured to identify one or more authorized users of the plurality of users to enable access to the at least one virtual file cabinet. In some embodiments, the user associated with the file cabinet may select other users to receive authorization. For example, the user may submit instructions at the mobile device via the mobile application instructions to designate one or more users as authorized to access the one or more documents, and the system may identify one or more authorized users based upon the received instruction. The user may submit similar instructions through another channel, such as through interaction within the virtual environment itself and/or through another computing device. In various embodiments, the system may automatically determine who should have access to the virtual lock box. For example, the system may identify any agents associated with the user and/or any other individuals involved in claims submitted by the user (e.g., other parties of an event, other insurers, police officers, repair technicians, etc.) as authorized to access one or more of the documents stored in association with the virtual file cabinet.

In the exemplary embodiment, the system may be configured to provide access to the one or more documents in response to the identified one or more authorized users interacting with the virtual file cabinet in the virtual environment. For example, the authorized users may open, click, or tap on, or otherwise interact with the virtual file cabinet in the virtual environment, which may enable the authorized users to view of download the documents. In some embodiments, the documents may be viewed within the virtual environment. Additionally, or alternatively, accessing the documents in the virtual environment may trigger a download or other transfer of data that may enable the documents to be viewed through a different channel, such as through the mobile app, web page, and/or another type of file-viewing application.

### Providing Real Time Event Support in a Virtual Environment

In the exemplary embodiment, the system may provide for a real time event support in the virtual environment. The system may receive sensor data from the user devices (e.g., data captured by smart glasses or other devices including other wearable devices, computer devices), which may be used to determine if an event (e.g., a vehicular collision, a weather event, natural disaster, or other event resulting in injury and/or property damage) has occurred. In various environments, the system may utilize historical sensor data corresponding to an asset involved in the event. The historical data includes sensor data that may have been previously captured and is associated with the asset. In response to detecting an event and/or receiving input from the user (e.g., as a voice command) that an event has occurred (e.g., in some cases the event may be a simulated or user created event), the system may prompt the user to interact with a live agent and/or replicant persona in the virtual environment as described above.

The system may provide guidance and/or instructions to the user via the user device, for example, as prompts displayed within the virtual environment and/or instructions provided by an agent avatar. These prompts may include text or speech (e.g., speech associated with the virtual avatars described above). The prompts may include questions verifying that the user is not injured or to provide information about what has occurred. For example, the prompts may instruct the user to take pictures and/or ask questions to others present at the scene of the event.

The user device may also passively collect data, such as image and/or audio data, in response to the event being detected. This collected information may be used to determine if additional resources, such as emergency personnel or insurance personnel, need to be contacted, and automatically initiate such contact (e.g., by initiating an emergency “9-1-1” call and/or presenting an agent avatar within the virtual environment as described above). The collected information may further be used to generate digital twins, simulations, and/or visual reconstructions of the event, which may be used to determine an extent of damage or injury that has occurred and the cause of the event, such vehicle component or system malfunction to properly assign fault. In various embodiments, these reconstructions may be viewed within the virtual environment.

In the exemplary embodiment, the system may be configured to receive sensor data from the user devices. For example, at least some of the user device may include cameras, microphones, motion sensors (e.g., accelerometers and/or gyroscopes), location sensors (e.g., GPS), radar, lidar, and/or any other types of sensors. This data may be received (e.g., continuously or periodically) prior to, during, and following an event. As described in further detail below, this senor data may be used by the system to determine when an event has occurred and to gather information about the nature, scene, context, and results of the event.

In the exemplary embodiment, the system may be further configured to determine, based upon the received sensor data, that an event simulation selection has occurred. The determination may be made by analyzing audio, video, and/or motion data, received from the user device. For example, the system may use AI and/or machine learning techniques and/or by comparing such data to one or more predefined thresholds indicative of an event for simulation from the user device (e.g., recognizing water damage to determine a flood has occurred or recognizing impact damage on a roof to determine a hailstorm has occurred). The event simulation includes a virtual representation of at least one asset before, during and after the selected event simulation within the virtual reality environment. Displaying the asset during all phases of the event may enable the at least one user to experience the event in a risk-free environment while also providing an understanding of how the event may have damaged or how it could damage the asset. In other embodiments, the virtual environment may allow the user to reverse engineer the damage to an asset caused by the selected event to view the pre-event state of the asset or experience the event that caused the damage to the asset. Simulating the event in the virtual environment provides full immersion within the virtual environment allowing the user to see, hear, feel, and smell the event safely to better understand the effects of the event on the asset. For example, simulating the event in the virtual environment may allow a user and an agent to inspect an asset during all phases of the event to determine prevention strategies and better understand strategies to insure the asset.

In various embodiments, the determination on whether an event has occurred may be made based upon detected voice, speech, facial expressions, and/or gestures made by the user or other individuals in the area. For example, the system may utilize specific voice commands or phrases made by the user (e.g., saying “in an event”) to determine an event has occurred and initiate an appropriate response. Additionally, or alternatively, the system may analyze non-structured speech or voice (e.g., using AI and/or chatbots) to determine that the non-structured speech or voice indicates an event has occurred. When it is determined an event has occurred, the user may be alerted to launch or access the virtual environment via the user device using voice commands.

In certain embodiments, the system may be configured to detect one or more voice commands input by the first user to the first user device. As described above, some of these voice commands may relate to an indication that an event has occurred. Additionally, the voice commands may request specific actions, such as contacting an agent (e.g., by saying “contact my agent”) or calling emergency services (e.g., by saying “call 9-1-1”).

The system may analyze these voice commands (e.g., using AI and/or chatbots and/or by performing a lookup based upon the received speech) to determine an appropriate response. For example, saying “contact my agent” may bring the agent, agent staff, agent machine learning bot/avatar or replicant persona, or claim representative into the metaverse channel for discussion or other interaction with the user. Additionally, or alternatively, the system may present within the virtual environment to an agent using an agent device of the user devices, a prompt to communicate with the user within the virtual environment. As described above, the system may generate responses to be performed by avatars and/or recommended to live agents and/or other agent personnel and may retrieve relevant policy documents for review by the agent. In some embodiments, the system may determine to perform these actions (e.g., contacting emergency personnel) even without a specific voice command. For example, if the system determines a sufficiently severe event has occurred, the system may automatically contact emergency personnel through an appropriate channel to request assistance and/or provide relevant information (e.g., a location of the event and/or identities of persons involved).

In some example embodiments, in response to determining the event has occurred, the system may be configured to present within the virtual environment one or more prompts for collecting information relating to the event using the user device. The prompts may be presented as text, audible commands, and/or statements made by avatars within the virtual environment. Examples of such prompts may include instructions to take pictures of the event scene and where and/or questions to ask others at the scene of the event. In certain embodiments, these prompts may be generated using AI and/or chatbot technology, for example, to gather as much information as possible relevant to completing an insurance claim. The system may record interactions or other information resulting from the user following these instructions. This information, such as the captured pictures and/or statements made by others at the scene of the event (e.g., witness accounts of what happened, statements indicating what happened, contact information, etc.), may be transmitted by the user device back to the system to be recorded and/or analyzed further.

As described herein, the system may automatically identify other individuals at the scene of the event. For example, the system may detect one or devices proximate to the user device (e.g., using Bluetooth device identification and/or another appropriate form of wireless communication), and may perform a lookup to identify individuals present at a scene of the event based upon the detected one or more devices. In certain embodiments, the system may identify individuals based upon detecting and analyzing voices of or statements made by the individuals detected by the user device.

In the exemplary embodiment, the system may be further configured to generate an event profile including the information collected by the user using the first user device in response to the one or more prompts. The event profile may be a database, database component, and/or data structure that stores various types of information associated with the event. In addition to the sensor data and information gathered by the user associated with the event, other relevant data may be recorded in association with the event profile, such as a date, time, location, weather, traffic, maps, geographic models or vehicle models, and/or other data associated with or providing context to the event. For example, the database includes historical data associated with the asset. The historical data may include previous images of the asset, drone images of the asset, or geospatial mappings of the asset. In some embodiments, the system may retrieve additional documents, such as a police report, insurance policy documents, insurance claim documents, and/or estimates or receipts from experts associated with the event and store these documents in association with the event profile.

The system may generate one or more digital twins representing people, vehicles, or other objects involved in the event and/or a visual representation and/or reconstruction of the event based upon information included in the event profile. For example, the system may parse the event profile for sensor data, historical data, speech data, and/or documents relating to the event to identify positions and orientations of relevant people and objects during the course of the event. In some embodiments, AI and/or machine learning techniques may be utilized for such parsing. In some embodiments, the system may cause the visual representation to be presented within the virtual environment, so that agents or others reviewing the event may do so in a three-dimensional environment.

At least one of the technical problems addressed by this system may include: (i) improving interactions in virtual reality by detecting and mimicking certain mannerisms and personality traits of a user including the emotions of the user and the subject matter of the conversation during the interaction with the user; (ii) improving accuracy of artificial intelligence driven avatars in virtual reality; (iii) improving the human response to interactions with AI driven avatars; (iv) providing access to interact remotely with agents in an environment simulating a face-to-face interaction; (v) facilitating an exchange of information through a virtual environment by enabling recording interactions within the environment and triggering exchange of information through different channels in response to interactions within the virtual environment; (vi) improving interactions within a virtual environment by providing recommendations for responding to user input including voice, gestures, and facial expressions; (vii) providing an ability to display an event (e.g., actual or selected) and/or the consequences of an event on an asset thereby providing users the ability to view, experience or evaluate the consequences of an event; (viii) providing an ability for a plurality of individuals to review events and/or consequences of an actual event, in real-time, immediately after the event has occurred.

The computer-based or computer-implemented methods and computer systems described herein may be implemented (i) using computer programming or engineering techniques including computer software, firmware, hardware, or any combination or subset thereof, and/or (ii) by using one or more local or remote processors, transceivers, servers, sensors, servers, scanners, AR or VR headsets or glasses, smart glasses, wearables, smart watches, dermal patches, mobile devices, laptops, video game systems, drones, camera systems, and/or other electrical or electronic components, wherein the technical effects may be achieved by performing at least one of the following action or operations: (1) communicate with the one or more user devices to cause the one or more user devices to present the virtual environment including at least one item or asset of a first user associated with a first user device; (2) receive sensor data from the first user device of the one or more user devices; (3) select a simulated event involving the at least one item or asset based upon an input from the one or more user devices; (4) generate the simulated event involving the at least one item or asset and using the received sensor data for display within the virtual environment; and/or (5) cause the simulated event involving the at least one item or asset to be displayed within the virtual environment to the first user using the first user device and at least a second user associated with a second user device of the one or more user devices, wherein the first user and the second user visually experience the simulated event via the respective first user device and the second user device.

### Exemplary Event Evaluation System

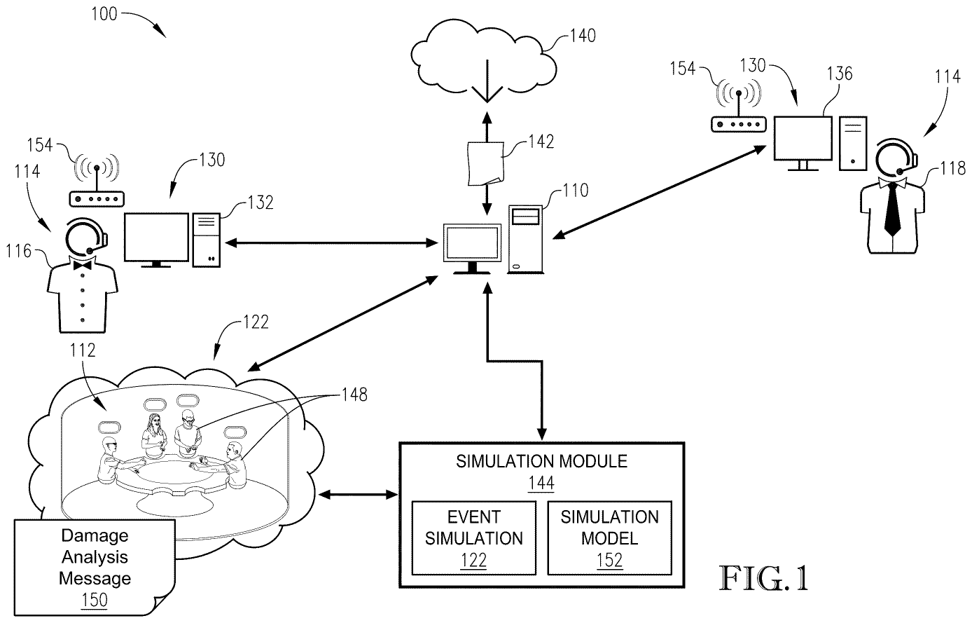

FIG. 1 depicts a simplified schematic diagram of a system 100 including an event simulation computing device 110 for supporting virtual reality (VR) environments 112 enabling interactions between one or more users 114 within the VR environment 112. For example, the VR environment 112 may enable at least one client 116 to interact with an agent 118 (e.g., an insurance agent) during one or more event simulations 122 including the VR environment 112.

The event simulation computing system 110 is communicatively coupled to one or more additional user computer devices 130 associated with the one or more users 114, e.g., a user computing device 132 associated with the client 116, and an agent computing device 136 associated with the agent 118. The event simulation computing device 110 is communicatively coupled to a database 140 (e.g., a cloud-based storage device), which may store client data 142, item or asset data, event data, and any historical interaction between a client 116 and agent 118. The system 100 further includes a simulation module 144 for generating one or more event simulations 122 (e.g., including one or more VR environments 112, one or more avatars 148 representing one or more users 114, and/or one or more damage analysis messages 150), described below, which may be presented (e.g., within the virtual environment 112) to the client 116 and/or the agent 118 during an event simulation 122.

In embodiments described herein, the system 100 may support a plurality of different event simulations 122 including a plurality of different VR environments 112 and/or a plurality of different users 114 (e.g., avatars 148 of different clients 116). For example, and without limitation, the system 100 may generate the VR environment 112 including an item or asset, representative of an actual or simulated asset, the environment around the asset, and/or an environment associated with the event simulation 122. The VR environment 112 may include a representation of an actual, or simulated, residential property associated with the item or asset (e.g., an interior of a home, a neighborhood including one or more residential properties and surrounding structures or objects including trees, houses, roads, etc.). In the illustrated embodiment, the VR environment 112 is embodied as an interior room of a residential home associated with the client 116.

The simulation module 144 includes a simulation model 152, e.g., a machine learning or artificial intelligence based, that may be trained using event data 142. One or more inputs may be applied to the simulation model 152 and the simulation model 152 may generate one or more outputs. For example, the simulation model 152 may be used to generate one or more outputs including simulation event 122 (e.g., generating the VR environment 112 and/or one or more avatars 148), enabling the client 116 to interact with the avatars 148 within the VR environment 112. The simulation model 152 may also be used to generate the one or more damage analysis messages 150. In certain embodiments, the simulation module 144 may store and/or retrieve from the database 140, one or more pre-generated simulation events 122 (e.g., suitable for various events associated with assets of the client 116). The simulation module 144, and/or the agent 118, may select a simulation event 122 from pre-generated simulation event 122 for simulation with the client 116.

The model 152 may generate an asset specific simulation event 122 that is tailored to the type of item or asset associated with the client 116. In some embodiments, the simulation model 152 may be re-trained using event data 142 associated with the client 116, e.g., during prior events associated with the client 116 in event simulations 122. Additionally, or alternatively, the event data 142 (sensor or other data associated with the item or asset) associated with the client 116 may be applied as an input to the trained simulation model 152. In some embodiments, the agent 118 may provide client 116 specific feedback regarding the damage to an asset during an event simulation and the feedback may be used to re-train the simulation model 152 using the feedback and/or the feedback may be applied as an input to the simulation model. For example, during an event simulation, the agent 118 or the simulation module 144 may identify the damage to the asset for the client 116 based upon the event simulation displayed in the virtual environment 112 and/or the simulation model's 152 evaluation of the event simulation 122 corresponding to the damage analysis message 150. Further, the simulation model 152, may generate a new, asset specific simulation event 122 associated with damage to an asset to recreate the event that caused the damage.

In some embodiments, the simulation module 144 may generate a plurality of pre-generated simulation events 122 including various levels of damage. For example, each of the pre-generated simulation event 122 may be associated with an amount of damage to the asset. Lower damage may correspond to a non-insurable event. For example, a low damage pre-generated simulation event 122 may be associated with minor hail damage and the VR environment 112 may include an exterior of residential homes with views of damage to a roof and/or siding. A high damage pre-generated event simulation 122 may be associated with a total loss caused by a flood and the VR environment 112 may include an interior of a residential home with views of the flood damaged basement of the residential home. The simulation module 144 and/or the agent 118 may select a pre-generated event simulation based upon the asset associated with the client 116. In some embodiments, the pre-generated simulation event 122 may be generated based upon a prior historical event (e.g., a historical loss and/or a known risk event associated with the asset). In some embodiments, the simulation model 152 generates simulation events 122 that may be based upon a plurality of historical losses and/or historical risk events associated with the asset. The simulation module 144, and/or the simulation model 152, may generate pre-generated simulation event 122 based upon selected criteria, e.g., selected by the agent 118 or the client 116. Selected criteria may include, for example and without limitation, various types of losses (e.g., hail, fire, flood, hurricane, weather event, or any other event resulting in injury and/or property damage), various levels of loss (e.g., partial loss, total loss, covered losses, and/or uncovered losses), and various types of assets (e.g., real property, personal property, buildings, etc.).

The agent 118 and the client 116 may be represented within the VR environment 112 as an avatar 148. In some embodiments, the avatar 148 represents an actual user 114, either while the user 114 is actively interacting with the system 100, e.g., in real-time while one or more sensors 154 of the user computer devices 130 is collecting data associated with the user 114, or alternatively, while the user 114 is not actively interacting with the system 100, e.g., the avatar 148 has been trained to represent the users 114 based upon the previous behavior, statements or phrases, and/or mannerisms of the user 114. For example, the client 116 may interact with the system 100 for an event simulation 122 while the agent 118 is not necessarily interacting with the system 100, e.g., conserving employee resources. For example, the client 116 may interact with an avatar 148 representing an agent 118 who is not currently interacting with the system, and then during a subsequent portion of the event simulation, the client 116 may interact with an avatar 148 representing an agent 118 who is currently interacting with the system 100, enabling the agent 118 to provide actual feedback in real-time.

In some embodiments, the avatar 148 may not necessarily represent a singular actual user 114, rather, the avatar 148 is trained to represent a plurality of different users 114. For example, the avatar 148 may be artificially generated (referred to herein as an AI generated avatar 148), e.g., the avatar 148 does not represent of an actual user 114, but rather an artificial representation of the actual user 114. In some embodiments, the system 100 may generate various versions of the avatar 148 to improve or facilitate the simulation event 122.

The client 116 computing device 124 may display the VR environment 112 and the avatars 148, e.g., the avatar 148 of the agent 118, and/or the avatar 148 of the client 116, within the VR environment 112. Each of the user computer devices 130 may display the VR environment 112 and/or one or more of the avatars 148. In the illustrated embodiment, the system 100 may cause the client computing device 132 and/or the agent computing device 136 to display one or more damage analysis messages 150. In some embodiments, the damage analysis message 150 is not displayed on the client computing device 132.

In embodiments described herein, the damage analysis messages 150 may be generated by the agent 118 and/or a simulation model 152 trained using event data 142. The damage analysis messages 150 may include communication (e.g., text and/or audio) for directing and/or providing feedback to the client 116 about damage to an asset caused by the event. The communication may provide a recommendation to the client 116 to mitigate risks to the asset associated with the event (e.g., trimming trees near a house, replacing outdated appliances, etc.). In some embodiments, the damage analysis messages 150 may provide the client 115 with a detailed report of the damage caused to the asset by the simulated event. In some embodiments, the damage analysis message 150 may present information, e.g., claim details, policy details, costs of items, etc., to the client 116 associated with the damage caused by the event simulation. The damage analysis message 150 includes details of the event that caused the damage. The damage analysis message 150 includes a description of the cause of the damage. In some embodiments, the damage analysis message 150 is generated by the simulation model 152, then transmitted to the agent computing device 136 where the damage analysis message 150 is reviewed or edited, before the communication is subsequently transferred to the client computing device 132 for being displayed to the client 116.

In embodiments described herein, the simulation module 144 may include a plurality of different simulation models 152 each trained using different training dataset. For example, the simulation model 152 may include a damage identification model that is trained to generate the simulation event 122 including a virtual environment 112 and one or more avatars 148 to identify the event that caused damage to an asset. The simulation module 144 may also include a damage risk model that is trained to identify risks of damage to the asset based upon asset data. The simulation module 144 may include an event simulation model that is trained to generate the damage analysis message 150, in real-time, during a current interaction and/or during the event simulation 122. In some embodiments, the simulation model 152 is a single or individual model, and inputs may be applied, e.g., in one instance, to generate a plurality of outputs including one or more simulation event 122, one or more avatars 148, and/or one or more damage analysis messages 150.

### Exemplary Computer Network

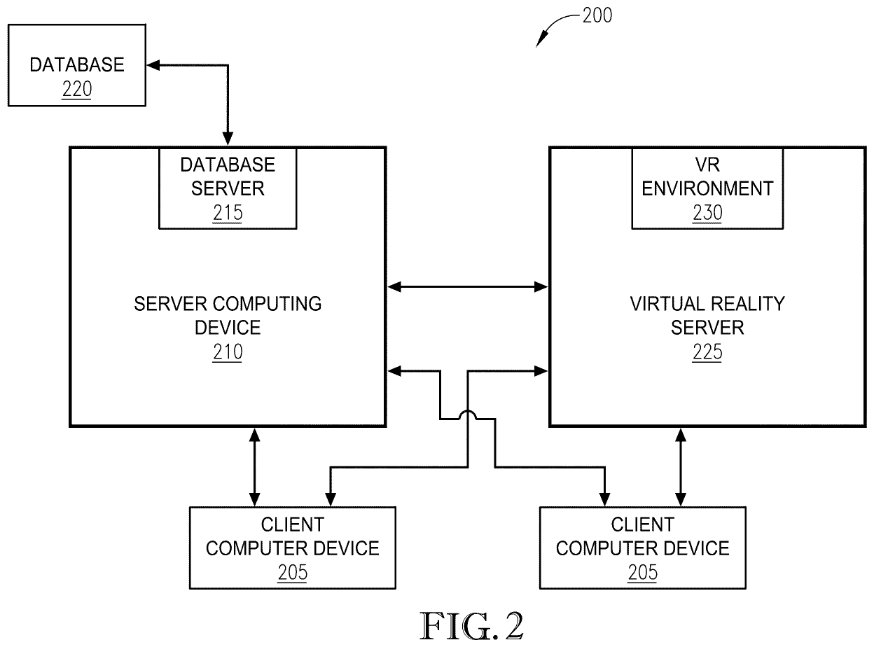

FIG. 2 depicts a simplified block diagram of an exemplary computer system 200. In the exemplary embodiment, system 200 may be used for providing a VR environment to enable a user to interact with a live or virtual agent.

In the exemplary embodiment, client computer devices 205 may be computers that include a web browser or a software application, which may enable client computer devices 205 to access server computing device 210 using the Internet. More specifically, client computer devices 205 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Client computer devices 205 may include the user device and/or agent interface described herein.

Client computer devices 205 may be any device capable of accessing the Internet including, but not limited to, a mobile device, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), smart glasses, a kiosk, a drone, chat bots, or other web-based connectable equipment or mobile devices. In some embodiments, client computer devices 205 may be capable of accessing VR environments 230, such as through virtual reality servers 225.

A database server 215 may be communicatively coupled to a database 220 that stores data. In one embodiment, database 220 may include scan files, replicant personas, digital twins, VR environments 230, business information, user information, and/or user preferences. In the exemplary embodiment, database 220 may be stored remotely from server computing device 210 and/or virtual reality server 225. In some embodiments, database 220 may be decentralized. In the exemplary embodiment, a person may access database 220 via client computer devices 205 by logging onto server computing device 210 and/or virtual reality server 225, as described herein.

Server computing device 210 may be communicatively coupled with one or more the client computer devices 205. In some embodiments, server computing device 210 may be associated with or is part of a computer network associated with business, or in communication with the business'computer network (not shown). In other embodiments, server computing device 210 may be associated with a third party and is merely in communication with the business'computer network. In some of these embodiments, server computing device 210 is associated with a virtual reality server 225.

One or more virtual reality servers 225 may be communicatively coupled with server computing device 210. The one or more virtual reality servers 225 each may be associated with a VR environment 230. Virtual reality servers 225 may provide tools and/or applications for users to access their associated VR environments 230 over the Internet. For the purposes of this discussion, VR environments 230 provide immersive environments that simulates how a user receives stimuli in the real world.

In one example, virtual reality (VR) goggles allow a user to see a virtual world. The VR goggles determines when the user turns their head and then renders imaging of what is where the user is looking. Furthermore, the user may use input tools, such as controllers to interact with the environment displayed by the goggles. A user may then interact with digital objects or avatars that have been added to the VR environment 230.

In some embodiments, VR environments 230 simulate parts or portions of the real-world and allow users to own and alter locations in the VR environments 230. For example, a user may own a plot of virtual land and build a version of their real-world house on that plot of land. Or a business could build an office or shop to allow users to interact with the replicant persona avatars in that office or shop.

In the exemplary embodiment, server computing device 210 and/or virtual reality server 225 may communicate with a user device (e.g., client computer device 205) to cause the user device to present VR environment 230. Server computing device 210 and/or virtual reality server 225 may provide video data, audio data, or other data (e.g., haptic feedback data) that may be presented to the user by the user device. Server computing device 210 and/or virtual reality server 225 may receive user input data such as live audio data, live video data, or live motion data from the user device, and based upon this received user input data, server computing device 210 and/or virtual reality server 225 may continually update the VR environment 230. For example, the system may respond to motion, voice commands or other speech, and/or other input (e.g., facial expressions) of the user. In some embodiments, if server computing device 210 and/or virtual reality server 225 determines that the user is visiting a location within the VR environment 230 based upon the input data, an agent or other individual associated with the location may receive a notification.

In the exemplary embodiment, server computing device 210 may generate a proposed response to a user based upon received user input data. User input that indicates a response may be required may include questions input by the user (e.g., as voice or text) or other actions by the user. For example, if the user is not talking but has a confused facial expression, server computing device 210 may determine that information or some other assistance should be offered to the user. The proposed response may include information to provide the user (e.g., specific language to speak to the user and/or documents to provide to the user), motions or gestures to performed by the agent avatar, or other actions.

In some embodiments, these responses may include actions outside of the VR environment 230, such as sending emails, phone messages, and/or text messages to the user. For example, if the user agrees to a purchase within the VR environment 230, server computing device 210 may transmit documents for the user to sign or forms for the user to submit payment information as an email and/or web link. In some embodiments, transmission of these documents may be triggered by analogous actions in the VR environment 230, such as by dropping a document into a virtual mailbox. In some embodiments, these responses may include real-time binding offers or quotes (e.g., insurance quotes), to which the user may accept within the VR environment 230. These may be generated based upon data provided by the user within the VR environment 230 and/or other retrieved data about the user (e.g., from a user profile and/or other web sources or databases such as database 220 accessible by server computing device 210). Any input from the user or agent may be recorded by server computing device 210 to enable such transactions to be processed and referred back to in the future.

In the exemplary embodiment, when server computing device 210 generates a proposed response, server computing device 210 may determine whether an agent is present at an agent interface (e.g., client computer device 205). For example, server computing device 210 may determine whether the agent is logged in and/or has made any input through the user interface (e.g., speech, motion, keystrokes, etc.) within a threshold period of time.

When the agent is present at the agent interface, server computing device 210 may cause the agent interface to display a recommendation including the proposed response. For example, the recommendation may be displayed as an overlay within the VR environment 230 visible to the agent, although not visible to the user or others accessing the VR environment 230.

In these cases, the recommendations may direct the agent on how to respond to questions, statements, gestures, facial expressions, and/or other actions made by the user. For example, if server computing device 210 determines the user is becoming confused during an interaction with the agent, the generated recommendations may direct the agent to slow down and/or offer additional explanation. These recommendations may be generated using one or more chatbots and/or using AI programs such as ChatGPT. In some embodiments, if the user and agent speak different languages, server computing device 210 may provide translation in real time.

In the exemplary embodiment, when the agent is not present at the agent interface, server computing device 210 may cause that at least one avatar to perform the proposed response based upon a replicant persona associated with the agent. In such cases, the avatar may replicate the traits of the agent including, but not limited to, the mannerisms, appearance, personality, historical and conversational talking points. Actions or responses of the replicant persona may be generated using one or more chatbots and/or using AI programs such as ChatGPT. Accordingly, the avatar may act as a user interface for the business when the agent is not present or unavailable, with the avatar interacting with users to provide information about and to collect information for the business.

For instance, a replicant persona for an agent or other representative for a business may be created and stored. When a user in a virtual reality environment walks into the virtual reality representation of the business, the user is greeted by an avatar of the agent that may answer questions and potentially handle the user's request(s). In some embodiments, a new avatar (e.g., each representing the agent) may be generated to interact with each user. These could be multiple avatars each connected to different personas or multiple avatars with the same persona. Therefore, multiple users could be interacting with their own version of the avatar of the agent, simultaneously. This allows the business to provide a personal, singular engagement.

In a further example, an avatar generated to interact with a user may be trained to interact with the user within the metaverse in accordance with certain traits of the agent learned through virtual or actual interaction with the user. In one example, the traits of the agent may include the agent's body language, the agent's speaking accent and/or dialect observed from an initial interaction (real or virtual) with the agent for a specific training period (e.g., initial 5 minutes or 10 minutes). Additionally, or alternatively, the traits of the agent may be retrieved from a database in which the agent's profile and the traits of the agent may be stored.

In some embodiments, the avatar may be interacting with the user to sell a new product or service (e.g., insurance products) for the user's insurable assets, such as newly purchased home or vehicle or other property, or the avatar may be interacting with the user for a claim submitted by the user for an event, a loss of a vehicle, or damage to the user's home, and so on. Accordingly, the avatar may be trained to show empathy, excitement, joy, kindness, or some other emotion that is appropriate with the cause of the interaction with the user. Additionally, or alternatively, certain traits or mannerisms of the avatar representing the agent, which may help to increase the user's confidence and trust in the product and/or service being marketed or sold by the avatar, may be used to train the avatar to incorporate those traits and/or mannerisms into the avatar during interaction with the user. In some cases, those traits or mannerisms incorporated into the agent's avatar may include similar traits and mannerism expressed by the user or the user's avatar.

In some embodiments, the avatar may initially be controlled by a live agent, for example, to respond to or greet the user, and/or to interact with the user to provide answers or information to the user. However, based upon the monitoring of the virtual interaction between the avatar being controlled by the real agent and the user, if it is determined that the interaction is not meeting a specific criterion, for example, the real agent's interactions with the user may be not generating the desired responses or feedback from the user, the avatar may be controlled by an artificial intelligence (AI) model or a machine-learning model to meet the specific criterion. For example, the real agent may be having a bad day, and, therefore, may be unable to show an appropriate level of empathy to the user while interacting with the user. Upon detecting such a condition or feedback from the user, server computing device 210 may control the avatar via the AI model or the ML model to adjust the level of empathy being presented to the user. Conversely, if is determined that a computer-controlled avatar is a specific criterion, server computing device 210 may alert a live agent to take control of the avatar.

In some examples, based upon an agent profile of the agent or historical interactions with the agent, if it is determined that the agent has a specific accent or dialect associated with a specific geographic location, the avatar may interact with the user using the specific accent or dialect. If it is learned that the agent frequently uses jokes, or one-liners while interacting, the avatar may be trained to use similar behavior while interacting with the user, which is likely to increase a comfort level of the user while interacting with the agent's avatar.

In addition, using a microphone and/or a camera, the agent's facial gestures, hand gestures, body language, and so on, may be recorded (e.g., while the agent is controlling the avatar live) and used for training the avatar to interact with the user in a specific way. An artificial intelligence (AI) model or a machine-learning (ML) model may be used to train the avatar to identify which traits of the agent may be beneficial to mimic or reproduce to increase the user's trust and confidence, and/or which traits of the agent may not be used by the avatar. The AI or ML model may also be used to train the avatar to use empathy corresponding to the cause of interaction with the avatar. For example, if the user has acquired an insurable asset, such as bought a new home or vehicle and is interacting with the avatar to purchase a new insurance policy, the avatar may use a happy or celebration tone while interacting with the user. Similarly, if the user is interacting with the avatar to report a damage or injury claim, the avatar may use a more supportive tone while interacting with the user.

The replicant persona, based upon which the avatar may be controlled, may be generated using one or more of Deep/Machine Learning (ML), Natural Language Processing (NLP), Voice Intelligence, and Artificial Intelligence (AI) to digitally replicate physical features and personality traits, mannerisms, voices, conversational style, quirks, interactions, facial expressions, hand gestures and/or other visible or audible mannerisms, and historical data and roles of the agent. The replicant persona is then used to generate one or more avatars to create unique and personalized experiences for users in a virtual reality or augmented reality space.

Data used to develop this replicant persona may include, but is not limited to, all available interactions from movies, videos, social media posts, interviews, recordings, images, scripts, other sources where a person's (e.g., an agent's) true personality and style could ultimately be captured, and/or current or previous interactions with the user. These data points could then be synthesized by deep/machine learning and cognitive computing and AI Voice subfields to accurately represent the agent and how they might respond given certain inputs and scenarios while interacting with the user.

The replicant persona may be used to generate individual avatars for different interactions. In some further embodiments, the individual avatar may be loaded with or have access to information about the individual user that the avatar is interacting with. For example, the avatar may know the user's name and call them by name directly. In a business interaction, the avatar may know additional information about the user, up to and including account details and/or other private or personally identifiable information.

In some embodiments, where the person (e.g., agent) to be represented by the avatar is available, server computing device 210 may use a 3-D indexing tool to scan the agent. The 3-D indexing tool may scan and capture the physical essence of the agent including, but not limited to physical attributes, tattoos, hair style, make-up, clothing, and other interesting aspects of the agent to use with an avatar that interacts with the user.

In some examples, a user may use his/her user avatar to interact with the virtual reality environment, including interacting with other user avatars in the environment. While a user avatar represents the individual user on a one-to-one basis, a replicant persona may have multiple avatars executing simultaneously in different areas of the virtual reality. For example, a first user may be in a virtual room with a first avatar of the replicant persona, while a second user is in a separate virtual room with a second avatar of the same replicant persona. The first user and the second user may be able to separately and simultaneously interact with their own avatar of the replicant person.

In the exemplary embodiment, server computing device 210 may provide for a secure exchange of documents and/or other data using a virtual file cabinet mechanism. The virtual file cabinet may enable a user to securely store documents and to authorize other users to access the documents. For example, a user may, through input (e.g., within virtual environment 230, a mobile app, and/or web page) designate documents (e.g., insurance policy documents, insurance cards, and/or documents and/or other data relating to insurance claims) to be stored in the virtual file cabinet, or the documents may automatically be stored in association with the virtual file cabinet in response to certain events (e.g., purchase or renewal of an insurance policy and/or filing of an insurance claim). The user may also designate other users (e.g., agents, other individuals involved in an insurance claim) to access any of these stored documents, or server computing device 210 may determine which individuals to authorize access to certain documents stored within the virtual file cabinet. These authorized users may than retrieve, view, and/or trigger a download of these documents, for example, by accessing the virtual file cabinet within virtual environment 230. In embodiments in which the virtual file cabinet includes insurance-related documents, such access may enable authorized users to quickly access these documents and determine insurance coverage in real time in case of an event or other insurance-related event.

In the exemplary embodiment, server computing device 210 may be configured to communicate with one or more user devices to cause those user devices to present virtual environment 230 to include at least one virtual file cabinet associated with a first user. In some embodiments, the virtual file cabinet may appear similar to an actual file cabinet or any other item (e.g., a safe or a file cabinet) users would likely understand to indicate a secure place to store documents. Alternatively, the virtual file cabinet may appear as any other type of item, point, or node within virtual environment 230 labeled as such (e.g., an icon or button). As described above, each user may have a corresponding user avatar, which may interact with the virtual file cabinet within virtual environment 230 analogously to how a person may interact with a file cabinet in real life (e.g., opening or closing and/or depositing or withdrawing documents). As described in further detail below, access to and/or the appearance of the file cabinet to a particular user may be controlled based upon whether the particular user is authorized to access any documents stored in the virtual file cabinet. Within virtual environment 230, the virtual file cabinet may include and/or be labeled with text or indicators providing information about the virtual file cabinet (e.g., which user is associated with the file cabinet, a relationship between the viewer and the user is associated with the file cabinet, and/or whether the viewer has access to any documents in the virtual file cabinet). For example, the file cabinet may include a lock that requires a combination or code to be entered to allow a user to access documents included within the file cabinet. A different code may be tied to the different documents included with in the virtual file cabinet such that when a code is entered only the documents linked to that code may be shown and may be accessible by that user.

In the exemplary embodiment, server computing device 210 may be configured to store one or more documents in the memory in association with the virtual file cabinet. For example, the user may designate documents to store in association with the virtual file cabinet or server computing device 210 may automatically determine and store or suggest storing, documents in association with the virtual file cabinet. In some embodiments, the user may input instructions at a mobile device via a mobile application to store documents in associated with the at least one virtual file cabinet. Server computing device 210 may then store the one or more documents in association with the at least one virtual file cabinet in response to receiving the instruction. In some embodiments, the user may generate user input data (e.g., by making corresponding movements and gestures) with the user device that indicates an intention to store the one or more documents in association with the virtual file cabinet (e.g., dragging and placing, or selecting from a menu). Server computing device 210 may then store the one or more documents in association with the virtual file cabinet in response to receiving this user input data. In some embodiments, server computing device 210 may automatically identify documents to store. For example, server computing device 210 may identify any insurance policy document, insurance cards, and/or insurance claim documents that may be associated with the user, and may automatically store the documents or generate recommendations for the user to store the documents in the virtual file cabinet.

In the exemplary embodiment, server computing device 210 may be configured to identify one or more authorized users of the plurality of users to enable access to the at least one virtual file cabinet. In some embodiments, the user associated with the file cabinet may select other users to receive authorization. For example, the user may submit instructions at the mobile device via the mobile application instructions to designate one or more users as authorized to access the one or more documents, and server computing device 210 may identify one or more authorized users based upon the received instruction. The user may submit similar instructions through another channel, such as through interaction within virtual environment 230 itself and/or through another computing device. In some embodiments, server computing device 210 may automatically determine who should have access to the virtual lock box. For example, server computing device 210 may identify any agents associated with the user and/or any other individuals involved in claims submitted by the user (e.g., other parties of an event, other insurers, police officers, repair technicians, etc.) as authorized to access one or more of the documents stored in association with the virtual file cabinet.

In the exemplary embodiment, server computing device 210 may be configured to provide access to the one or more documents in response to the identified one or more authorized users interacting with the virtual file cabinet in virtual environment 230. For example, the authorized users may open, click or tap on, or otherwise interact with the virtual file cabinet in virtual environment 230, which may enable the authorized users to view of download the documents. In some embodiments, the documents may be viewed within virtual environment 230. Additionally, or alternatively, accessing the documents in virtual environment 230 may trigger a download or other transfer of data that may enable the documents to be viewed through a different channel, such as through the mobile app, web page, and/or another type of file-viewing application.

In the exemplary embodiment, server computing device 210 may provide for a real time event support in virtual environment 230. Server computing device 210 may receive sensor data from the user devices (e.g., data captured by smart glasses), which may be used to determine if an event (e.g., an accident or other event resulting in injury and/or property damage) has occurred. In response to detecting an event and/or receiving input from the user (e.g., as a voice command) that an event has occurred, server computing device 210 may prompt the user to interact with a live agent and/or replicant persona in virtual environment 230 as described above.

Server computing device 210 may provide guidance and/or instructions to the user via the user device, for example, as prompts displayed within virtual environment 230 and/or instructions provided by an agent avatar. These prompts may include text or speech (e.g., speech associated with the virtual avatars described above). The prompts may include questions verifying the event or to provide information about what has occurred. For example, the prompts may instruct the user to take pictures and/or ask questions about the event.

The user device may also, with the user's permission or consent, passively collect data, such as image and/or audio data, in response to the event being detected. This collected information may be used to determine if additional resources, such as emergency personnel or insurance personnel, need to be contacted, and automatically initiate such contact (e.g., by initiating an emergency “9-1-1” call and/or presenting an agent avatar within virtual environment 230 as described above). The collected information may further be used to generate digital twins, simulations, and/or visual reconstructions of the event, which may be used to determine an extent of damage or injury that has occurred and the cause of the event, such as which vehicle or vehicle system was at fault for the event. In some embodiments, these reconstructions may be viewed within virtual environment 230.

In the exemplary embodiment, server computing device 210 may be configured to receive sensor data from the user devices. For example, at least some of the user device may include cameras, microphones, motion sensors (e.g., accelerometers and/or gyroscopes), location sensors (e.g., GPS), radar, lidar, and/or any other types of sensors. This data may be received (e.g., continuously or periodically) prior to, during, and following an event. As described in further detail below, this senor data may be used by server computing device 210 to determine when an event has occurred and to gather information about the nature, scene, context, and results of the event.

In the exemplary embodiment, server computing device 210 may be further configured to determine, based upon the received sensor data, that an event has occurred. In some embodiments, this determination may be made by analyzing audio, video, and/or motion data, for example, using AI and/or machine learning techniques and/or by comparing such data to one or more predefined thresholds indicative that an event has occurred (e.g., recognizing water damage to determine a flood has occurred or recognizing impact damage on a roof to determine a hailstorm occurred).

In some embodiments, the determination may be made based upon detected voice, speech, facial expressions, and/or gestures made by the user or other individuals in the area. For example, in some embodiments, server computing device 210 may utilize specific voice commands or phrases made by the user (e.g., saying “in an event”) to determine an event has occurred and initiate an appropriate response. Additionally, or alternatively, server computing device 210 may analyze non-structured speech or voice (e.g., using AI and/or chatbots) to determine that the non-structured speech or voice indicates an event has occurred. When it is determined an event has occurred, the user may be alerted to launch or access virtual environment 230 via the user device using voice commands.

In some embodiments, server computing device 210 may configured to detect one or more voice commands input by the first user to the first user device. As described above, some of these voice commands may relate to an indication that an event has occurred. Additionally, the voice commands may request specific actions, such as contacting an agent (e.g., by saying “contact my agent”) or calling emergency services (e.g., by saying “call 9-1-1”). Server computing device 210 may analyze these voice commands (e.g., using AI and/or chatbots and/or by performing a lookup based upon the received speech) to determine an appropriate response. For example, saying “contact my agent” may bring the agent, agent staff, agent machine learning bot/avatar or replicant persona, or claim representative into the metaverse channel for discussion or other interaction with the user. For example, server computing device 210 may present within the virtual environment to an agent using an agent device of the user devices, a prompt to communicate with the user within the virtual environment.

As described above, server computing device 210 may generate responses to be performed by avatars and/or recommended to live agents and/or other agent personnel, and may retrieve relevant policy documents for review by the agent. In some embodiments, server computing device 210 may determine to perform these actions (e.g., contacting emergency personnel) even without a specific voice command. For example, if server computing device 210 determines a sufficiently severe event has occurred, server computing device 210 may automatically contact emergency personnel through an appropriate channel to request assistance and/or provide relevant information (e.g., a location of the event and/or identities of persons involved).

In the exemplary embodiment, in response to determining the event has occurred, server computing device 210 may be configured to present within virtual environment 230 one or more prompts for collecting information relating to the event using the user device. The prompts may be presented as text, audible commands, and/or statements made by avatars within virtual environment 230. Examples of such prompts may include instructions to take pictures of the event scene and where and/or questions to ask others at the scene of the event. In some embodiments, these prompts may be generated using AI and/or chatbot technology, for example, to gather as much information as possible relevant to completing an insurance claim. Server computing device 210 may record interactions or other information resulting from the user following these instructions. This information, such as the captured pictures and/or statements made by others at the scene of the event (e.g., witness accounts of what happened, statements indicating what happened or indications innocence, contact information, etc.), may be transmitted by the user device back to server computing device 210 to be recorded and/or analyzed further.

In some embodiments, server computing device 210 may automatically identify other individuals at the scene of the event. For example, server computing device 210 may detect one or devices proximate to the user device (e.g., using Bluetooth device identification and/or another appropriate form of wireless communication), and may perform a lookup to identify individuals present at a scene of the event based upon the detected one or more devices. In some embodiments, server computing device 210 may identify individuals based upon detecting and analyzing voices of or statements made by the individuals detected by the user device.

In the exemplary embodiment, server computing device 210 may be further configured to generate an event profile including the information collected by the user using the first user device in response to the one or more prompts. The event profile may be a database, database component, and/or data structure (e.g., stored in database 220) that stores various types of information associated with the event. In addition to the sensor data and information gathered by the user associated with the event, other relevant data may be recorded in association with the event profile, such as a date, time, location, weather, traffic, maps, geographic models or vehicle models, and/or other data associated with or providing context to the event. In some embodiments, server computing device 210 may retrieve additional documents, such as a police report, insurance policy documents, insurance claim documents, and/or estimates or receipts from mechanics associated with the event and store these documents in association with the event profile.

In some embodiments, server computing device 210 may generate one or more digital twins representing people, vehicles, or other objects involved in the event and/or a visual representation and/or reconstruction of the event based upon information included in the event profile. For example, server computing device 210 may parse the event profile for sensor data, speech data, and/or documents relating to the event to identify positions and orientations of relevant people and objects during the course of the event. In some embodiments, AI and/or machine learning techniques may be utilized for such parsing. In some embodiments, server computing device 210 the visual representation may be presented within virtual environment 230, so that agents or others reviewing the event may do so in a three-dimensional environment.

### Exemplary Client Device

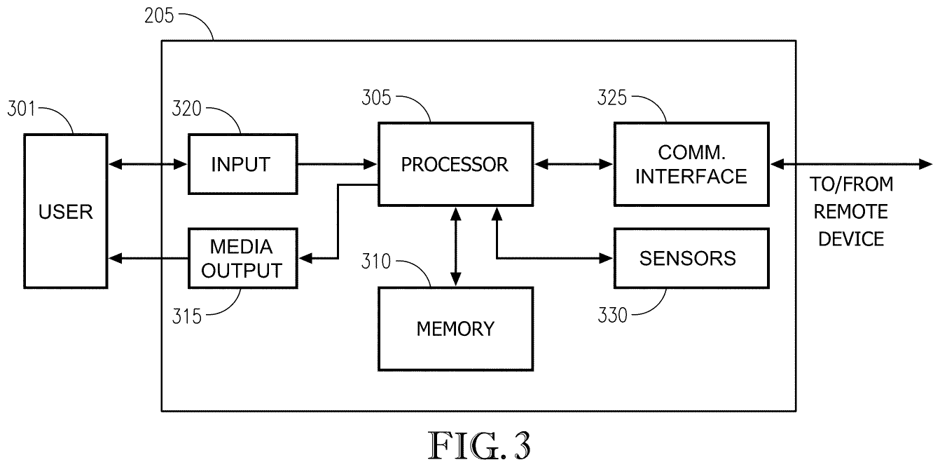

FIG. 3 depicts an exemplary configuration of a client computer device 205 shown in FIG. 2, in accordance with one embodiment of the present disclosure. Client computing device 205 may be operated by a user 301. Client computing device 205 may include a processor 305 for executing instructions. In some embodiments, executable instructions may be stored in a memory area 310. Processor 305 may include one or more processing units (e.g., in a multi-core configuration). Memory area 310 may be any device allowing information such as executable instructions and/or transaction data to be stored and retrieved. Memory area 410 may include one or more computer readable media.

Client computing device 205 may also include at least one media output component 315 for presenting information to user 301. Media output component 315 may be any component capable of conveying information to user 301. In some embodiments, media output component 315 may include an output adapter (not shown) such as a video adapter and/or an audio adapter. An output adapter may be operatively coupled to processor 305 and operatively couplable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (eXtended Reality) headsets).

In some embodiments, media output component 315 may be configured to present a graphical user interface (e.g., a web browser and/or a client application) to user 301. A graphical user interface may include, for example, an online store interface for viewing and/or purchasing items, and/or a wallet application for managing payment information. In some embodiments, client computing device 205 may include an input device 320 for receiving input from user 301. User 301 may use input device 320 to, without limitation, select and/or enter one or more items to purchase and/or a purchase request, or to access credential information, and/or payment information.

Input device 320 may include, for example, a keyboard, a pointing device, a mouse, a stylus, a touch sensitive panel (e.g., a touch pad or a touch screen), a gyroscope, an accelerometer, a position detector, a biometric input device, an audio input device (e.g., a microphone), and/or a video input device (e.g., a camera). A single component such as a touch screen may function as both an output device of media output component 315 and input device 320.

Client computing device 205 may also include a communication interface 325, communicatively coupled to a remote device such as server computing device 210 (shown in FIG. 3). Communication interface 325 may include, for example, a wired or wireless network adapter and/or a wireless data transceiver for use with a mobile telecommunications network.

Stored in memory area 310 may be, for example, computer readable instructions for providing a user interface to user 301 via media output component 315 and, optionally, receiving and processing input from input device 320. A user interface may include, among other possibilities, a web browser and/or a client application. Web browsers enable users, such as user 301, to display and interact with media and other information typically embedded on a web page or a website from the server computing device 210 and/or the virtual reality server 225. A client application allows user 301 to interact with, for example, the server computing device 210 and/or the virtual reality server 225. For example, instructions may be stored by a cloud service, and the output of the execution of the instructions sent to the media output component 315.

Processor 305 executes computer-executable instructions for implementing aspects of the disclosure. In some embodiments, the processor 305 is transformed into a special purpose microprocessor by executing computer-executable instructions or by otherwise being programmed.

### Exemplary Server Device

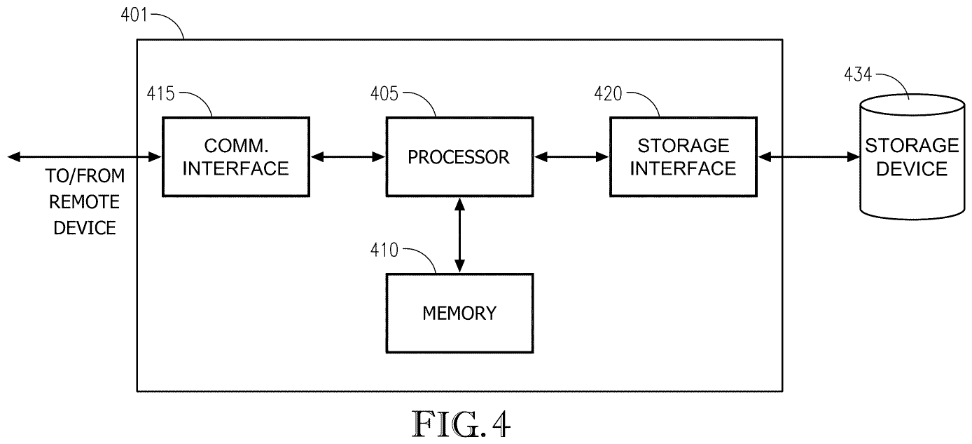

FIG. 4 depicts an exemplary configuration of a server computing device 401, in accordance with one embodiment of the present disclosure. Server computer device 401 may include, but is not limited to, server computing device 210 and/or virtual reality server 225 (all shown in FIG. 2). Server computer device 401 may also include a processor 405 for executing instructions. Instructions may be stored in a memory area 410. Processor 405 may include one or more processing units (e.g., in a multi-core configuration).

Processor 405 may be operatively coupled to a communication interface 615 such that server computer device 401 is capable of communicating with a remote device such as another server computer device 401, virtual reality server 225, or client computer devices 205 (shown in FIGS. 1 and 2). For example, communication interface 415 may receive requests from client computer devices 205 via the Internet.

Processor 405 may also be operatively coupled to a storage device 134. Storage device 434 may be any computer-operated hardware suitable for storing and/or retrieving data, such as, but not limited to, data associated with database 220 (shown in FIG. 2). In some embodiments, storage device 434 may be integrated in server computer device 401. For example, server computer device 401 may include one or more hard disk drives as storage device 434.

In other embodiments, storage device 434 may be external to server computer device 401 and may be accessed by a plurality of server computer devices 401. For example, storage device 434 may include a storage area network (SAN), a network attached storage (NAS) system, and/or multiple storage units such as hard disks and/or solid state disks in a redundant array of inexpensive disks (RAID) configuration.

In some embodiments, processor 405 may be operatively coupled to storage device 434 via a storage interface 420. Storage interface 420 may be any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

Processor 405 may execute computer-executable instructions for implementing aspects of the disclosure. In some embodiments, the processor 405 may be transformed into a special purpose microprocessor by executing computer-executable instructions or by otherwise being programmed.

### Exemplary Computer-Implemented Method for Generating a Geospatial Mapping of a Virtual Environment

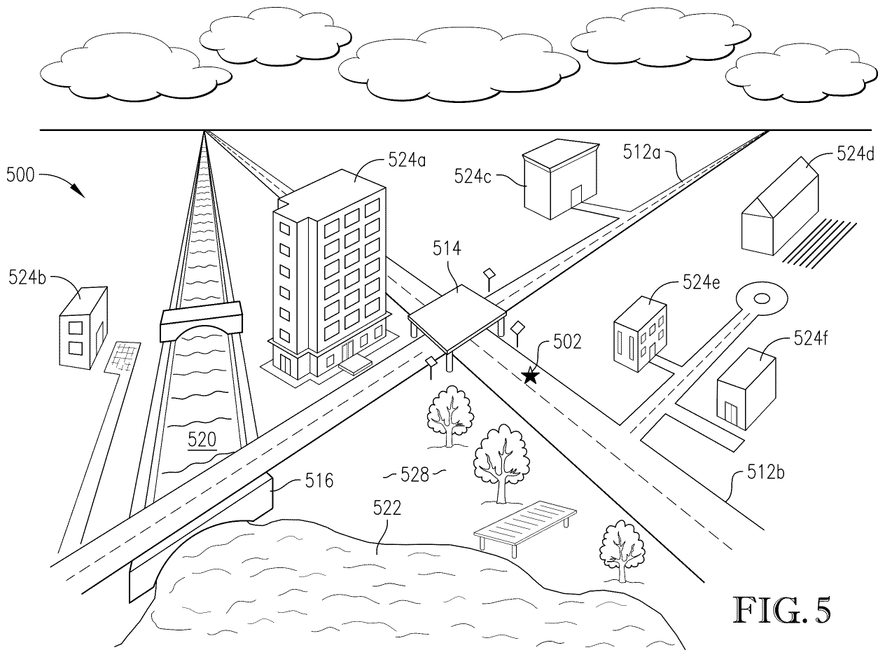

FIG. 5 illustrates an exemplary virtual landscape 500 that may be generated and provided to one or more users in a virtual environment via the techniques described herein. The virtual landscape 500 may be generated and provided via computing elements of the virtual experience system depicted in FIGS. 1 and/or 2, and/or via other suitable computing elements. The virtual landscape 500 may include additional, fewer, or alternate elements to those depicted in FIG. 5, including any components of a virtual landscape described in this detailed description. In various embodiments, the virtual landscape 500 includes the asset associated with the user. For example, a virtual simulation of the asset associated with a user 502 (e.g., user 114) is provided within the virtual landscape 500.

The view of the virtual landscape 500 in FIG. 5 corresponds to just one possible view of the three-dimensional virtual space of the virtual landscape 500 that includes the asset. While this “overhead” view is provided for clarity and ease of description, a typical view for a user in the virtual landscape may correspond to a viewing perspective (e.g., position and viewing angle) of the user 502 (also referred to herein as “user position 502”). The viewing perspective of the user 502 may vary in accordance with the user's navigation about the virtual landscape 500 using tools described herein, and thus, numerous views of the virtual landscape 500 may be possible. Although a view from the perspective of the user 502 typically may be a “ground-level” view, the user 502 may, in some embodiments, move vertically about the virtual landscape 500 so as to achieve an overhead view of the virtual landscape 500 resembling the view illustrated in FIG. 5.

The layout of the virtual landscape 500 generally includes terrain upon which two major roads 512a and 512b may be situated. The roads 512a and 512b intersect at an intersection 514. Various components may be present at the intersection 514, including but not limited to signs, traffic lights, vehicles, and/or utility components (e.g., power lines) providing electricity to and/or other components of the virtual landscape 500. The road 512a includes a bridge portion 516 via which the road 512a passes over a river 520. The river 520 passes under the bridge portion 516 and leads into a lake 522.

The virtual landscape 500 includes a plurality of virtual properties 524a-524f, which may include various commercial properties, residential properties, and/or other properties described herein, including combinations thereof. For example, the multi-level virtual property 524a may include a commercial property on a first floor, and other virtual commercial and/or residential properties on second, third, and fourth floors. Accordingly, any virtual property may be associated with one or more entities (e.g., property owners, renters, lessors, etc.). In some embodiments, the virtual landscape 500 may additionally or alternatively include an “undeveloped” property 528 (e.g., a property upon which a structure is not yet present or fully constructed), but which may still be considered for insurability based upon one or more aspects of the virtual landscape 500. In various embodiments, the plurality of virtual properties 524a-524f includes an asset corresponding to the user 502 such as a home or other insurable properties that may be represented as one of the virtual properties 524a-524f.

Various characteristics of the virtual landscape 500 may be randomly generated according to the techniques described herein. For example, procedural generation techniques may be applied to determine (1) material composition of structures upon the virtual properties 524a-524f, (2) varying elevation of the terrain of the virtual landscape 500, (3) rotation, size, and/or placement of various components of the virtual landscape 500, and/or (4) meteorological elements (e.g., clouds, rain, etc.) of the virtual landscape 500.

As described herein, the virtual experience system may generate personalized virtual content for a training program to provide a user with an event simulation training module. The user may provide the virtual experience system 100 with a selection of a desired training module and the virtual experience system 100 may generated personalized content based upon the received desired event simulation training module. For example, the event simulation training module may be associated with an event simulation selected by the user for the event simulation training module. The system 100 may generate a virtual environment, such as the landscape 500, based upon the desired training module. The system then may determine training content based upon the personal data and the desired training module.

Additionally, the system 100 may determine personalized virtual content in the form of virtual objects such as buildings, cars, rooms, landmarks, geological features, etc. based upon the determined training content. The system 100 may then generate one or more of the determined virtual objects based upon the virtual environment, the personal data, and the determined training content. The system 100 then provides, via a virtual experience interface device, such as a virtual headset, the virtual environment, one or more virtual objects, and the training content to the user of the system 100. In some examples, the user may interact in the virtual environment via interface hardware such as a keyboard, joystick, or other physical controller, or the user may provide inputs via a virtual user interface, motion tracking, and/or hand and gesture identification/tracking.

In the current example, generally, a training objective of the user 502 in the virtual landscape 500 is to identify one or more aspects affecting insurability of one or more virtual properties depicted therein. The user 502 may determine, for example, that a commercial property on the first floor of the virtual property 524a is associated with a business that is eligible for commercial insurance, but that is at increased risk of water-related damage in the event of flooding of the river 520. As another example, the user 502 may identify a construction material of a structure upon the virtual property 524d, to determine risk of damage to 524d (e.g., as a result of weather, natural disaster, human activity, etc.). As another example, the user 502 may identify that value (and thus, insurability) of the virtual property of the virtual property 528 may be affected by its proximity to the lake 522, even though a structure is not yet fully developed upon the virtual property 528. As will be described further herein, the virtual landscape 500 may incorporate various virtual tools that enable a user to identify one or more aspects affecting insurability of one or more virtual properties in the virtual landscape 500.

In some embodiments, a view of the user 502 in the virtual landscape 500 may comprise only a portion of the above-described components of the virtual landscape 500. In particular, due to computing limitations such as limited RAM, a view of the user 502 may be adjusted based upon computing capabilities of the device at which the virtual landscape 500 is provided. For example, when certain components of the virtual landscape 500 may be outside of a limited “draw distance” of the user 502, may be only in the periphery of the viewing angle of the user 502, or may be obstructed by other components of the virtual landscape 500, the view of the virtual landscape 500 (1) limit graphical resolution of those certain components, (2) limit the visual detail of those certain components (e.g., by not including smaller “sub-components”), and/or (3) may omit those certain components entirely.

### Exemplary Computer-Implemented Method for Interactions in a Virtual Environment

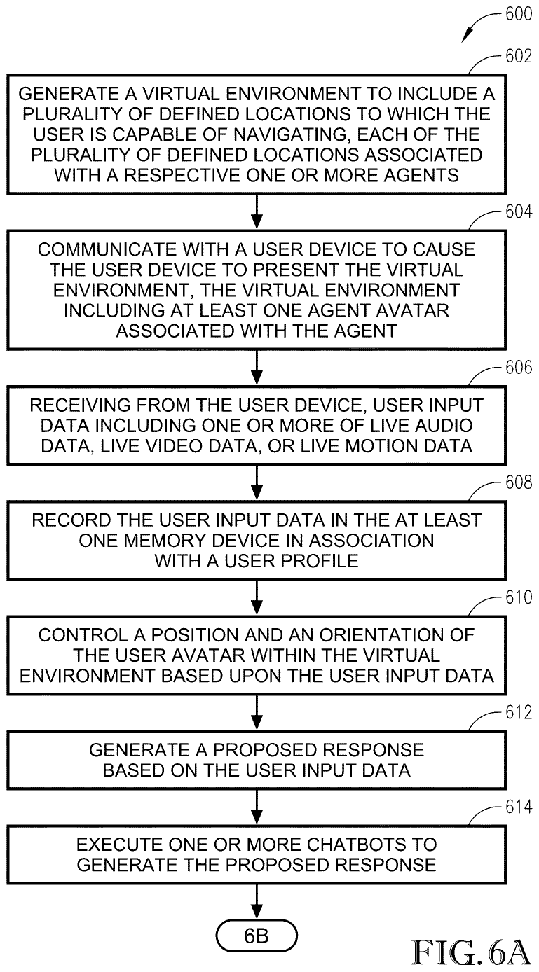

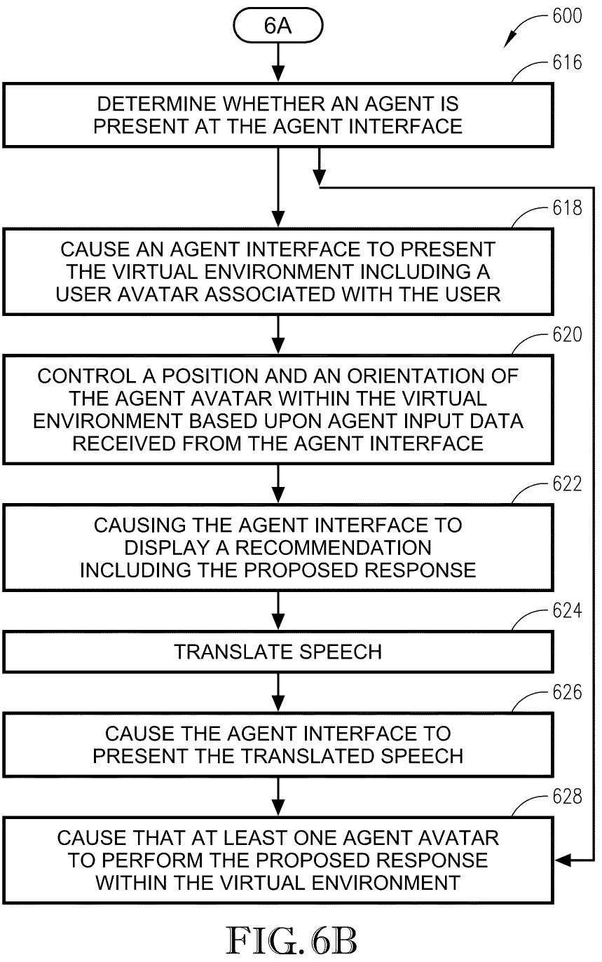

FIGS. 6A and 6B depict a flow chart of an exemplary computer-implemented process 600 for interaction with at least one user in a virtual environment using the system 100 shown in FIG. 1. Process 600 may be implemented by a computing device, for example server computing device 210 and/or virtual reality server 225 (shown in FIG. 2). In the exemplary embodiment, server computing device 210 may be in communication with one or more virtual reality servers 225 and one or more client computer devices 205 (both shown in FIG. 2).

In some embodiments, process 600 may include generating 602 the virtual environment to include a plurality of defined locations to which the user is capable of navigating, each of the plurality of defined locations associated with a respective one or more agents. In some embodiments, this action or operation may be performed by server computing device 210 and/or virtual reality server 225 (shown in FIG. 2).

In the exemplary embodiment, process 600 may include communicating 604 with the user device to cause the user device to present the virtual environment, the virtual environment including at least one agent avatar associated with the agent. In some embodiments, this action or operation may be performed by server computing device 210 and/or virtual reality server 225 (shown in FIG. 2).

In the exemplary embodiment, process 600 may further include receiving 606, from the user device, user input data including one or more of live audio data, live video data, or live motion data. In some embodiments, this action or operation may be performed by server computing device 210 and/or virtual reality server 225 (shown in FIG. 1).

In some embodiments, process 600 may further include recording 608 the user input data in the at least one memory device in association with a user profile. In some embodiments, this action or operation may be performed by server computing device 210 and/or virtual reality server 225 (shown in FIG. 2).

In some embodiments, process 600 may further include controlling 610 a position and an orientation of the user avatar within the virtual environment based upon the user input data. In some embodiments, this action or operation may be performed by server computing device 210 and/or virtual reality server 225 (shown in FIG. 2).

In the exemplary embodiment, process 600 may further include generating 612 a proposed response based upon the user input data. In some embodiments, this action or operation may be performed by server computing device 210 and/or virtual reality server 225 (shown in FIG. 2).

In some embodiments, process 600 may further include executing 614 one or more chatbots to generate the proposed response. In some embodiments, this action or operation may be performed by server computing device 210 and/or virtual reality server 225 (shown in FIG. 2).

In the exemplary embodiment, process 600 may further include determining 616 whether an agent is present at the agent interface. In some embodiments, this action or operation may be performed by server computing device 210 and/or virtual reality server 225 (shown in FIG. 2).

In some embodiments, process 600 may further include causing 618 the agent interface to present the virtual environment including a user avatar associated with the user. In some embodiments, this action or operation may be performed by server computing device 210 and/or virtual reality server 225 (shown in FIG. 2).

In some embodiments, process 600 may further include controlling 620 a position and an orientation of the agent avatar within the virtual environment based upon agent input data received from the agent interface. In some embodiments, this action or operation may be performed by server computing device 210 and/or virtual reality server 225 (shown in FIG. 2).

In the exemplary embodiment, process 600 may further include, when the agent is present at the agent interface, causing 622 the agent interface to display a recommendation including the proposed response. In some embodiments, this action or operation may be performed by server computing device 210 and/or virtual reality server 225 (shown in FIG. 2).

In some embodiments, the user input data includes speech, and process 600 further includes, when the agent is present at the agent interface, translating 624 the speech. In such embodiments, process 600 may further include causing 626 the agent interface to present the translated speech. In some embodiments, this action or operation may be performed by server computing device 210 and/or virtual reality server 225 (shown in FIG. 2).

In the exemplary embodiment, process 600 further includes, when the agent is not present at the agent interface, causing 628 that at least one agent avatar to perform the proposed response within the virtual environment. In some embodiments, this action or operation may be performed by server computing device 210 and/or virtual reality server 225 (shown in FIG. 2).

### Exemplary Computer-Implemented Method for Generating an Avatar

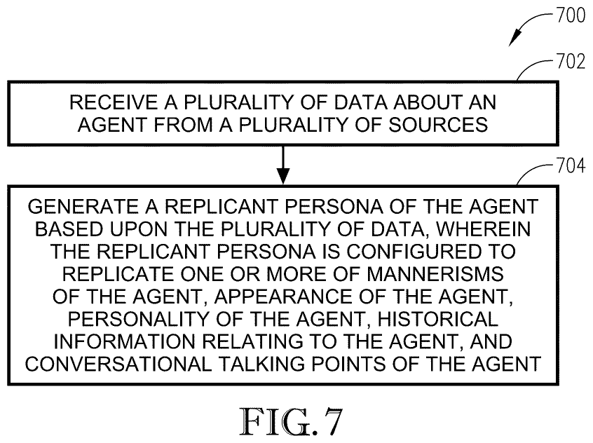

FIG. 7 depicts a flow chart of an exemplary computer-implemented process 700 for generating an avatar for an agent or other individual using system 100 shown in FIG. 1. Process 700 may be implemented by a computing device, for example server computing device 210 and/or virtual reality server 225 (shown in FIG. 1). In the exemplary embodiment, server computing device 210 may be in communication with one or more virtual reality servers 225 and one or more client computer devices 205 (both shown in FIG. 2).

In the exemplary embodiment, process 700 may include receiving 702 a plurality of data about the agent from a plurality of sources. In some embodiments, this action or operation may be performed by server computing device 210 and/or virtual reality server 225 (shown in FIG. 2).

In the exemplary embodiment, process 700 may include generating 704 a replicant persona of the agent based upon the plurality of data, wherein the replicant persona is configured to replicate one or more of mannerisms of the agent, appearance of the agent, personality of the agent, historical information relating to the agent, and conversational talking points of the agent. The proposed response referred to with respect to process 600 (shown in FIGS. 6A and 6B) may be generated based at least in part upon the replicant persona. In some embodiments, the mannerisms of the agent may include one or more of: hand gestures of the agent, facial gestures of the agent, body language of the agent, a speaking accent of the agent, a dialect of the agent, a personality of the agent, or emotions of the agent. In some embodiments, the plurality of data includes social media, behavior data from interviews, recordings, images, and/or historical data about the agent. In some embodiments, this action or operation may be performed by server computing device 210 and/or virtual reality server 225 (shown in FIG. 2).

### Exemplary Computer-Implemented Method for Providing Secure Data Exchange in a Virtual Environment

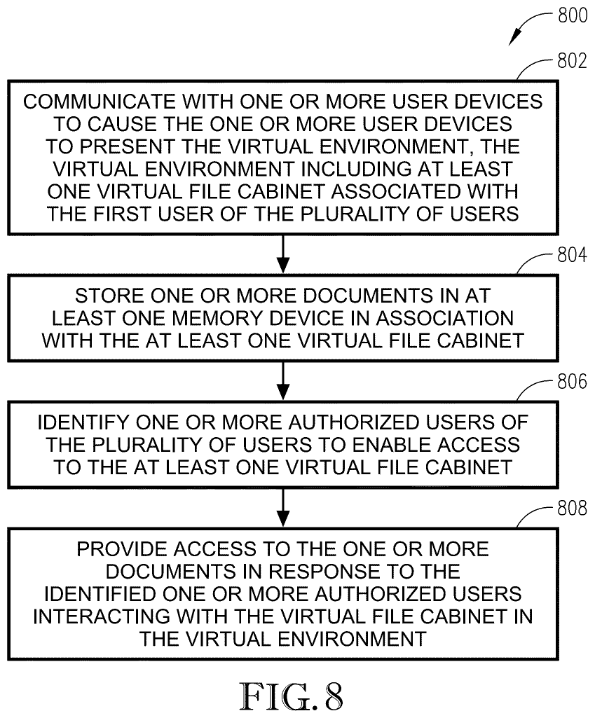

FIG. 8 depicts a flow chart of an exemplary computer-implemented process 800 for providing secure data exchange in a virtual environment such as virtual environment 230 using system 200 shown in FIG. 2. Process 800 may be implemented by a computing device, for example server computing device 210 and/or virtual reality server 225 (shown in FIG. 2). In the exemplary embodiment, server computing device 210 may be in communication with one or more virtual reality servers 225 and one or more client computer devices 205 (both shown in FIG. 2).

In the exemplary embodiment, process 800 may include communicating 802 with the one or more user devices to cause the one or more user devices to present the virtual environment, the virtual environment including at least one virtual file cabinet associated with a first user of the plurality of users. In some embodiments, this action or operation may be performed by server computing device 210 and/or virtual reality server 225 (shown in FIG. 2).

In the exemplary embodiment, process 800 may further include storing 804 one or more documents (e.g., event profiles, insurance or policy documents, asset data, or user information etc.) in the at least one memory device in association with the at least one virtual file cabinet. In some embodiments, this action or operation may be performed by server computing device 210 and/or virtual reality server 225 (shown in FIG. 2).

In the exemplary embodiment, process 800 may further include identifying 806 one or more authorized users of the plurality of users to enable access to the at least one virtual file cabinet. In some embodiments, this action or operation may be performed by server computing device 210 and/or virtual reality server 225 (shown in FIG. 2).

In the exemplary embodiment, process 800 may further include providing access 808 to the one or more documents in response to the identified one or more authorized users interacting with the virtual file cabinet in the virtual environment. In some embodiments, this action or operation may be performed by server computing device 210 and/or virtual reality server 225 (shown in FIG. 2).

### Exemplary Computer-Implemented Method for an Event Simulation

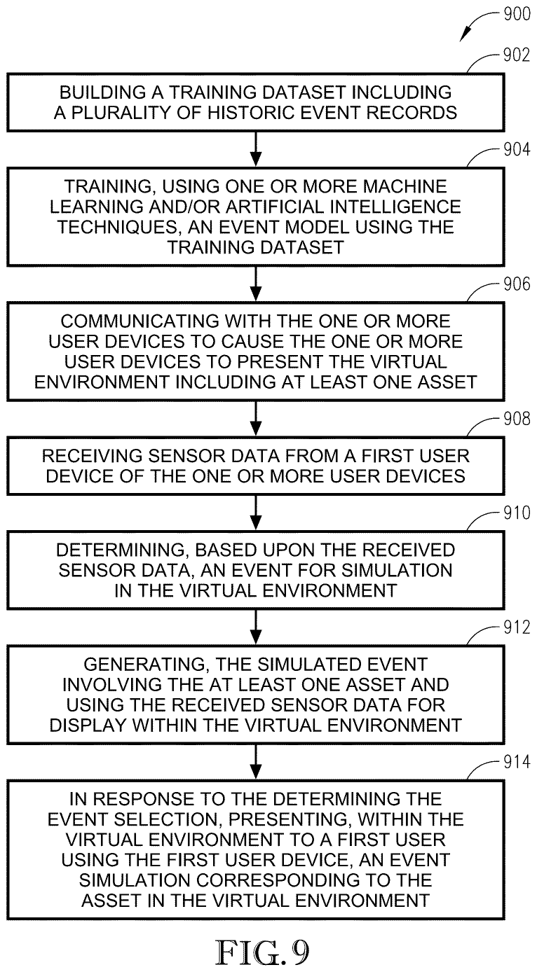

FIG. 9 depicts a flow chart of an exemplary computer-implemented process 900 for an event simulation in a virtual environment, such as virtual environment 230, using system 100 shown in FIG. 1. Process 900 may be implemented by a computing device, for example server computing device 210 and/or virtual reality server 225 (shown in FIG. 1). In the exemplary embodiment, server computing device 210 may be in communication with one or more virtual reality servers 225 and one or more client computer devices 205 (both shown in FIG. 2). The risks inherent in a given asset may be difficult to visualize and understand-both by a consumer having one or more insurance policies, as well as by insurance associates (e.g., sales associates, underwriters, and/or insurance providers). Understanding the coverage of the insurance policy for the asset is paramount in the business of insurance, as well as other property-related decision making processes for the user. A greater understanding of risks posed by natural conditions, hypothetical events, and trends may increase confidence in both situations. As used herein, a “natural event” includes any nature-related and/or nature-generated event, including, for example, floods, storms, lightning, wildfires, tornadoes, hurricanes, flash flooding, storm surge, tsunamis, earthquakes, mudslides, landslides, snow, ice, and/or blizzards.

In some embodiments, process 900 may include building 902 a training dataset including a plurality of historic event records. The plurality of historical event records may each be associated with one or more historical events (e.g., historic natural events or any event that may have had an impact on an asset. The historic event records may include historical policy information, historical sensor data, historical images (e.g., both before and after the event). In some embodiments, the historical event records may include any suitable additional or alternative data, e.g., client data, historical event details, such as flood levels, tornado rank (Enhanced Fujita Scale), precipitation level, etc.

In some embodiments, process 900 may include training 904, using one or more machine learning and/or artificial intelligence techniques, an event model using the training dataset. The trained event model may be trained to generate one or more model outputs including the simulated event when one or model inputs are applied. Model inputs may include one or more of sensor data, one or more inputs selected from the one or more user devices and/or a selection of simulated event. In some embodiments, process 900 may include applying model inputs to the event model, in real-time, during an event or immediately after the event, to generate a simulation of the event. Alternatively, the process 900 may include selectively applying model inputs to the trained model to generate simulated events.

In the exemplary embodiment, process 900 may include communicating 906 with one or more user devices to cause the one or more user devices to present a virtual environment 230 including at least one asset, e.g., an insured asset. In some embodiments, this action or operation may be performed by server computing device 210 and/or virtual reality server 225 (shown in FIG. 2).

In the exemplary embodiment, process 900 may further include receiving 908 sensor data from a first user device of the one or more user devices. In some embodiments, this action or operation may be performed by server computing device 210 and/or virtual reality server 225 (shown in FIG. 2).

In the exemplary embodiment, process 900 may further include determining 910, based upon the received sensor data, an event selection for simulation in the virtual environment. In certain embodiments, the process 900 may include receiving an event selection for simulation, e.g., from user computing device or agent computing. In some embodiments, this action or operation may be performed by server computing device 210 and/or virtual reality server 225 (shown in FIG. 2). In the exemplary embodiment, the user may determine the event selection using the user computing device. For example, the event selection includes fire damage, water damage, flooding, storm damage, roof damage, theft or burglary, vandalism, electrical surge damage, falling objects, mold, smoke, wildlife damage, septic system failure, and/or earthquake damage. The event selection may include various user-input variables to define the scope and severity of the selected event. In the exemplary embodiment, variables may include an amount of rainfall (in inches), a duration of rainfall (in hours), and/or a season (to set a groundwater baseline for the location including property). Additional, less, or alternate variables may be used, including wind speed, hail amount, and/or storm surge. In other embodiments, the variables of the event may be determined relative the event data associated with the selected event. The user may adjust the variables using associated controls such as sliders but may take any other form in alternate embodiments, including, for example, text fields, drop-down menus, arrow-key controls, or any other control. In various embodiments, the variables may be adjusted within the virtual environment 230.

Based upon the event selection, the event simulation may be generated to indicate at least one effect on the property due to the proposed event (i.e., a rainfall having the user-input variables described above). The event simulation may include the condition of the asset during the event and the condition of the asset after the event. An effect may include no damage, some damage, total property loss, partial property loss, land damage, and/or various other potential effects, which may be characterized using a loss estimate. The simulation may include various situation information determined by the conditions expressed by the user-input variables. In various embodiments the system includes an output sensor device connected to the user device that allows the user to experience the event within the virtual environment. For example, the output sensor provides visual, haptic, audio, and olfactory data to the user based upon the event simulation. The output sensor allows increases the user's immersion into the virtual environment while also providing them with a more accurate simulation of the event.

In the exemplary embodiment, process 900 may further include generating 912 the simulated event involving the at least one asset and using the received sensor data for display within the virtual environment. Process 900 may include providing a pre-event simulation of the asset. The simulation determines the effect(s) of various natural phenomena on a subject property to a user interface of a user computing device before, during, and after the event. In various embodiments, the system may utilize sensor data, historical data, and event data associated with an asset as input to a model to simulate the event. The model may process the sensor data, the historical data, and the asset data to generate an event simulation that includes the pre-event condition of the asset, the condition of the asset during the event, and the post-event condition of the asset. The model may utilize the sensor data, the historical data, and the event data to generate the pre-event condition of the asset based upon sensor data corresponding to a real-world post-event condition of an asset. In other embodiments, the system may generate a post-event condition of the asset based upon the sensor data, the historical data, and the event data.

For example, the asset is a property that may be located in an area prone to heavy rainfall and/or flooding. Accordingly, upon selection of the flooding event selection the user device event simulation may be generated by an insurance underwriter or a homeowner interested in the risk to property for flood damage (or other water-related damage or loss). Using traditional methods, the insurance underwriter or homeowner (“user”) may have had to consult various two-dimensional peril and/or topographical maps, as well as historical floodplain data, to attempt to ascertain the level of risk to property due to a flood or other damage from water source.

The virtual environment of the event simulation includes a plurality of possible views of the three-dimensional virtual environment. For example, an overhead view is described for clarity and ease of description, a typical view for a user in the virtual landscape may correspond to a viewing perspective (e.g., position and viewing angle) of a user within the virtual environment (also referred to herein as “user position”). The viewing perspective of the user may vary in accordance with the user's navigation about the virtual environment using tools described herein, and thus, numerous views of the virtual environment may be possible. Although a view from the perspective of the user typically may be a “ground-level” view, the user may, in some embodiments, move vertically about the virtual environment so as to achieve an overhead view of the asset. The layout of the virtual environment generally includes terrain upon which the asset is situated. Various other components may be present within the virtual environment, including but not limited to signs, traffic lights, vehicles, and/or utility components (e.g., power lines) associated with the virtual environment.

In some embodiments, a view of the user in the virtual environment may comprise only a portion of the above-described components of the virtual environment. In particular, due to computing limitations such as limited RAM, a view of the user may be adjusted based upon computing capabilities of the device at which the virtual environment is provided. For example, when certain components of the virtual environment may be outside of a limited “draw distance” of the user, may be only in the periphery of the viewing angle of the user, or may be obstructed by other components of the virtual environment, the view of the virtual environment may (1) limit graphical resolution of those certain components, (2) limit the visual detail of those certain components (e.g., by not including smaller “sub-components”), and/or (3) may omit those certain components entirely.

Various characteristics of the virtual environment may be randomly generated according to the techniques described herein. For example, procedural generation techniques may be applied to determine (1) material composition of structures within the virtual environment, (2) event simulation conditions, (3) rotation, size, and/or placement of various components of the virtual environment, and/or (4) meteorological elements (e.g., clouds, rain, etc.) of the virtual environment.

In the exemplary embodiment, process 900 may further include, in response to determining the event selection, presenting 914, an event simulation corresponding to the asset in the virtual environment 230. In some embodiments, this action or operation may be performed by server computing device 210 and/or virtual reality server 225 (shown in FIG. 2). The event simulation may further include a loss estimate, which communicates to the user the potential for loss or damage to the asset based upon the event selection. Loss estimate may be generated by the system using various internal underwriting information associated with the asset, including value of the asset and/or other specifications. For example, if an event simulation showed water levels that would damage a basement and a detached structure associated with the insured asst, the value (or percentage of total value) of those structures may be displayed to the user in the virtual environment, relative to the estimated severity and duration of the disaster (e.g., water levels high enough to flood a basement would not necessarily result in a total loss, but may result in a total loss for a detached structure that is submerged or washed away). In this way, the event simulation may quantify the risk of an event to the user and identify the recommendations for mitigation practices to align insurance coverage for the asset to risks.

Incentives may be offered to the user (or other users associated with the asset) that actively respond to the content shown in the event simulation, for example, by taking additional preventative or mitigating measures in the real world that were identified in the virtual simulation. For example, an insurance provider may offer a discount, credit, or service rebate to a homeowner that adds sandbags around property if the event simulation were to indicate that the asset is at risk of damage caused by a flood or other water-related event. Additionally, system may be configured to generate and/or display suggestions for such mitigating or preventative measures within the event simulation. For example, the risk mitigation strategy includes physical improvements, maintenance strategies, and implementing technologies and monitoring systems. System may receive an indication of user compliance with a risk-mitigating suggestion. System may then recommend or facilitate an adjustment in an insurance policy associated with the asset (e.g., one or more of the incentives described above).

In some embodiments, the process 900 may further include identifying at least one difference between a post-event state of an asset and a pre-event state of the asset. In addition, the method may include identifying an insurance policy associated with the asset and populating at least one field of the claims form based upon the at least one difference. The method may also include updating and/or adjusting, by the insurance server at the database, the insurance policy based upon the populated claims form.

Additionally, the virtual environment may be used to evaluate the condition of the asset pre-event, during the event, and/or post-event to evaluate the coverage of the insurance policy relative to the effects of the event. In this way, the system provides a virtual environment to experience loss to an asset in a safe, risk-free environment independent of the proximity of the user and the agent. Simulating the event in the metaverse provides users and agents to inspect the asset during all phases of the event simulation (e.g., pre-event, during the event, and post-event) in a risk-free simulation to better understand if any potential claims would be covered losses. Further, the simulated events allow users and agents to virtually inspect the asset to preemptively identify possible real-world events and take additional preventative or mitigating measures to ensure any possible claims would be covered and better understand the scope of the insurance coverage. For example, the event simulation may help users better match coverage of an insurance policy to the risk to the asset.

In alternative embodiments, the virtual environment may be used to identify and mitigate fraud. For example, the virtual environment may simulate a pre-event condition of the asset, generate various event simulations, and compare the actual damage caused by the event simulation to the potentially fraudulent damage. The simulation may compare the actual damage to the damage that occurs in the simulated event and provide identify the differences between the situations to detect potentially fraudulent damage.

In the current example, generally, an event simulation in the virtual environment is provided to identify one or more risks associated with the asset within the virtual environment. The user may determine, for example, that the asset is at increased risk of water-related damage in the event of flooding. As another example, the user may determine risk of damage to the asset resulting from the event (e.g., as a result of weather, natural disaster, human activity, etc.). As another example, the user may identify that value (and thus, insurability) of the asset within the virtual environment in a without damage to the asset. As will be described further herein, the virtual environment may incorporate various virtual tools that enable a user to identify one or more risks associated with the one or more assets in the virtual environment.

In various embodiments, the virtual environment may be used to identify and mitigate risk associated with the asset. For example, in a further enhancement of the systems and methods described herein, a user may select a user-input risk tolerance threshold for the event selection. The user (e.g., an owner of the asset or an insurance underwriter or associate) may establish a risk tolerance threshold based upon a level or severity of damage that may be acceptable or the maximum allowed for coverage. For example, the user may establish a risk tolerance threshold that flooding in a basement of the property is an acceptable amount of risk, but that flooding or damage to a main floor is unacceptable. System may use the risk tolerance threshold to generate one or more event simulations that report the particular conditions under which the risk tolerance threshold may be met (i.e., a particular characteristic of the event that satisfies the risk tolerance threshold). Accordingly, if a risk tolerance threshold established by an insurance provider indicates that flooding of any kind is unacceptable, and an event simulation generated by system 100 indicates that only minor weather conditions (e.g., average rainfall in any season) may produce a flood in the property and thereby satisfy the risk tolerance threshold, the insurance provider recommend mitigation strategies to reduce the risk associated with the simulated event.

The event information may alternatively include a loss estimate for the property. The insurance server may be configured to generate the loss estimate and/or to provide various underwriting and/or public information to facilitate the generation of the loss estimate. For example, the insurance server may use (or allow use of) an insurance policy associated with the property to determine a value of the property. Accordingly, if a pre-disaster reference request message is received that requests a risk assessment for the property for flood damage, the insurance server may use the value of the property to determine a loss estimate in the event that the basement (e.g., a particular percentage of the property) is flooded.

In various embodiments, the process 900 may include generating personalized virtual content for an event simulation. The user may provide the system 100 with a selection of a desired event simulation for an asset and the system 100 may generated personalized content based upon the received event simulation selection. The system 100 may generate a virtual environment based upon the desired event simulation. The system then may determine event simulation content based upon the personal data and the desired event simulation.

Additionally, process 900 may include determining personalized virtual content in the form of virtual objects such as buildings, cars, rooms, landmarks, geological features, etc. based upon the event simulation selection. The determination can be used to generate one or more of the determined virtual objects based upon the virtual environment, the personal data, the asset, and the selected event simulation. The generated virtual objects can be provided, via a client computer device, such as a virtual headset, the virtual environment, one or more virtual objects, and the event simulation to the user of the system. In some examples, the user may interact in the virtual environment via interface hardware such as a keyboard, joystick, or other physical controller, or the user may provide inputs via a virtual user interface, motion tracking, and/or hand and gesture identification/tracking.

The present embodiments may include the use of augmented reality technology to produce event simulations in the context of assets. Potential application and/or uses of the present embodiments may include: (i) enabling agents and/or underwriters to better understand and communicate the natural risk inherent in a particular property (e.g., by visualizing for a user their need for increased coverage related to a particular event); (ii) enabling better underwriting decision making (i.e., on the spot, inspection of the asset in the virtual environment); (iii) enabling users to make decisions about asset coverage, with respect to event risks; and/or (iv) enabling user to assess their own insurance risks, including their tolerance for risk and possible preventative mitigation efforts that could be taken.

### Exemplary Embodiments & Functionality

In one aspect, a computer system for generating a virtual reality replicant persona for interaction with at least one user may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computer system may include at least one local or remote processor and/or associated transceiver in communication with at least one local or remote memory device and in communication with a user device associated with a user and with an agent interface associated with an agent. The at least one processor may be programmed to: (1) communicate with the one or more user computer devices to cause the one or more user computer devices to present the virtual environment including at least one asset of a first user associated with a first user device; (2) receive sensor data from the first user device of the one or more user computer devices; (3) select a simulated event involving the at least one asset based upon an input from the one or more user computer devices; (4) generate the simulated event involving the at least one asset and using the received sensor data for display within the virtual environment; and/or (5) cause the simulated event involving the at least one asset to be displayed within the virtual environment to the first user using the first user device and at least a second user associated with a second user device of the one or more user computer devices, wherein the first user and the second user visually experience the simulated event via the respective first user device and the second user device.

In another aspect, a computer-implemented method for generating a virtual reality replicant persona for interaction with at least one user may be provided. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality glasses or headsets, voice bots or chatbots, ChatGPT or ChatGPT-based bots, and/or other electronic or electrical components, which may be in wired or wireless communication with one another. For example, in one instance, the computer-implemented method may be implemented by a computer system including at least one processor and/or associated transceiver in communication with at least one memory device and in communication with a user device associated with a user and with an agent interface associated with an agent. The method may include: (1) communicating, via the one or more processors, with the one or more user computer devices to cause the one or more user computer devices to present the virtual environment including at least one asset of a first user associated with a first user device; (2) receiving, via the one or more processors, sensor data from one or more sensors associated with the first user device of the one or more user computer devices; (3) selecting, via the one or more processors, a simulated event involving the at least one asset based upon an input from the one or more user computer devices; (4) generating, via one or more processors, the simulated event involving the at least one asset and using the received sensor data for display within the virtual environment; and/or (5) presenting, via the one or more processors, within the virtual environment to a first user using the first user device, an event simulation corresponding to the asset in the virtual environment. The method may include additional, less, or alternate actions, including those discussed elsewhere herein.

In yet another aspect, at least one non-transitory computer-readable media having computer-executable instructions embodied thereon may be provided. The computer-executable instructions may be executed by a computer system including at least one local or remote processor and/or associated transceivers in communication with at least one local or remote memory device and in communication with a user device associated with a user and with an agent interface associated with an agent. The computer-executable instructions may direct or cause the at least one processor to: (1) communicate with the one or more user computer devices to cause the one or more user computer devices to present the virtual environment including at least one asset of a first user associated with a first user device; (2) receive sensor data from the first user device of the one or more user computer devices; (3) select a simulated event involving the at least one asset based upon an input from the one or more user computer devices; (4) generate the simulated event involving the at least one asset and using the received sensor data for display within the virtual environment; and/or (5) cause the simulated event involving the at least one asset to be displayed within the virtual environment to the first user using the first user device and at least a second user associated with a second user device of the one or more user computer devices, wherein the first user and the second user visually experience the simulated event via the respective first user device and the second user device.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally, or alternatively, the machine learning programs may be trained by inputting sample data sets or certain data into the programs, such as image, mobile device, vehicle telematics, and/or intelligent home telematics data. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs and may seek to discover a general rule that maps inputs to outputs, so that when subsequent novel inputs may be provided the processing element may, based upon the discovered rule, accurately predict the correct output. In unsupervised machine learning, the processing element may be required to find its own structure in unlabeled example inputs. In one embodiment, machine learning techniques may be used to extract the relevant personal belonging and/or home feature information for customers from mobile device sensors, vehicle-mounted sensors, home-mounted sensors, and/or other sensor data, vehicle or home telematics data, image data, and/or other data.

In one embodiment, a processing element may be trained by providing it with a large sample of conventional analog and/or digital, still and/or moving (i.e., video) image data, telematics data, and/or other data of belongings, household goods, durable goods, appliances, electronics, homes, etc. with known characteristics or features. Such information may include, for example, make or manufacturer and model information.

Based upon these analyses, the processing element may learn how to identify characteristics and patterns that may then be applied to analyzing sensor data, vehicle or home telematics data, image data, mobile device data, and/or other data. For example, the processing element may learn, with the customer's permission or affirmative consent, to identify the type and number of goods within the home, and/or purchasing patterns of the customer, such as by analysis of virtual receipts, customer virtual accounts with online or physical retailers, mobile device data, interconnected or smart home data, interconnected or smart vehicle data, etc. For the goods identified, a virtual inventory of personal items or personal articles may be maintained current and up to date. As a result, at the time of an event that damages the customer's home or goods, providing prompt and accurate service to the customer may be provided—such as accurate insurance claim handling, and prompt repair or replacement of damaged items for the customer.

In some embodiments, voice bots or chatbots, such as those discussed herein, may be configured to utilize AI (artificial intelligence) and/or ML (machine learning) techniques. For instance, the chatbot may be a large language model such as OpenAI GPT-4, Meta LLaMa, or Google PaML 2. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples may be example only and may be thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of records or data that is stored in a computer system. The above examples may be not intended to limit in any way the definition and/or meaning of the term database. Examples of RDBMS's include, but may be not limited to, Oracle® Database, MySQL, IBM® DB2, Microsoft® SQL Server, Sybase®, and PostgreSQL. However, any database may be used that may enable the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.).

As used herein, the terms “software” and “firmware” may be interchangeable and include any computer program stored in memory for execution by a processor, including RAM memory, ROM memory, EPROM memory, EEPROM memory, and non-volatile RAM (NVRAM) memory. The above memory types may be example only and may be thus not limiting as to the types of memory usable for storage of a computer program.

In another embodiment, a computer program is provided, and the program is embodied on a computer-readable medium. In one exemplary embodiment, the system is executed on a single computer system, without requiring a connection to a server computer. In a further exemplary embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computer devices. One or more components may be in the form of computer-executable instructions embodied in a computer-readable medium. The systems and processes may be not limited to the specific embodiments described herein. In addition, components of each system and each process may be practiced independent and separate from other components and processes described herein. Each component and process may also be used in combination with other assembly packages and processes. The present embodiments may enhance the functionality and functioning of computers and/or computer systems.

As used herein, an element or action or operation recited in the singular and preceded by the word “a” or “an” should be understood as not excluding plural elements or action or operations, unless such exclusion is explicitly recited. Furthermore, references to “exemplary embodiment” or “one embodiment” of the present disclosure may be not intended to be interpreted as excluding the existence of additional embodiments that also incorporate the recited features.

The patent claims at the end of this document may be not intended to be construed under 35 U.S.C. § 112(f) unless traditional means-plus-function language is expressly recited, such as “means for” or “action or operation for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples may be intended to be within the scope of the claims if they have structural elements that do not differ from the literal language of the claims, or if they include equivalent structural elements with insubstantial differences from the literal language of the claims.

We claim:

1. A computer system for conducting interactions of a simulated event for a plurality of users in a virtual environment, the computer system comprising at least one processor and at least one memory device in communication with the at least one processor and one or more user computer devices, the at least one processor programmed to:
communicate with the one or more user computer devices to cause the one or more user computer devices to present the virtual environment including at least one item of a first user associated with a first user device of the one or more user computer devices;
receive sensor data from one or more sensors associated with the first user device, the sensor data including data related to the at least one item;
select a simulated event involving the at least one item based upon an input from the one or more user computer devices;
generate the simulated event involving the at least one item and using the received sensor data for display within the virtual environment; and
cause the simulated event involving the at least one item to be displayed within the virtual environment to the first user using the first user device and at least a second user associated with a second user device of the one or more user computer devices, wherein the first user and the second user visually experience the simulated event involving the at least item via the respective first user device and the second user device.

2. The computer system of claim 1, wherein the at least one processor is further programmed to:
build a training dataset including a plurality of historical event records for a plurality of different events;
train a first event model of a plurality of different event models, using one or more machine learning and/or artificial intelligence techniques, using the training dataset, wherein the first event model is trained to generate a first simulated event within the virtual environment; and
apply at least one of (i) the sensor data including image data of the at least one item, and (ii) input from the one or more user computer devices including a geographic location of the at least one item at a time when the simulated event occurs to the trained first event model to generate one or more model outputs for display within the virtual environment including a display of the first simulated event and an impact of the first simulated event on the at least one item.

3. The computer system of claim 1, wherein the at least one processor is further programmed to determine a damage to the at least one item in the event simulation, wherein determining the damage comprises processing item data representing the at least one item and event data representing the simulated event to compute a pre-event condition of the at least one item and at least one impact to the at least one item during the simulated event and after the simulated event.

4. The computer system of claim 1, wherein the at least one processor is further programmed to, in response to the selection of the simulated event, cause to be displayed in the virtual environment via the one or more user computer devices, at least one impact to the at least one item due to the simulated event, the at least one impact displayed as an overlay upon the at least one item as viewed within the virtual environment.

5. The computer system of claim 1, wherein the at least one processor is further programmed to:
enable the first user to contact an agent through the virtual environment by selecting a contact prompt displayed within a display device of the first user device; and
cause a response prompt to be displayed within the virtual environment, enabling the agent using an agent device of the one or more user computer devices to communicate with the first user within the virtual environment,
wherein the agent appears within the virtual environment as an avatar controlled by a replicant persona selectable by the first user.

6. The computer system of claim 1, wherein the at least one processor is further programmed to cause the virtual environment to be presented on the one or more user computer devices with sensory data as an output of the simulated event, wherein the sensory data outputted on the one or more user computer device includes: motion data, image data, audio data, haptic data, or olfactory data.

7. The computer system of claim 1, wherein the at least one processor is further programmed to:
modify the virtual environment based upon the simulated event selected from a plurality of selectable simulated events, wherein each simulated event includes an event profile containing data associated with the corresponding simulated event; and
input the event profile for the selected simulated event into a corresponding event model along with the sensor data associated with the at least one item to output the modified virtual environment showing within the virtual environment: (i) a virtual representation of the at least one item, prior to the simulated event, (ii) a virtual representation of the at least one item during the simulated event, and (iii) a virtual representation of the at least one item after the simulated event.

8. The computer system of claim 1, wherein the at least one processor is further programmed to identify a mitigation practice as part of the selected simulated event to reduce a likelihood of damage to the at least one item as caused by the simulated event.

9. The computer system of claim 1, wherein the at least one processor is further programmed to:
receive from the first user device policy identification data for identifying an insurance policy associated with the one or more items; and
perform a lookup in a database to locate policy documents, insurance cards, or insurance claim documents that are associated with the identified insurance policy.

10. The computer system of claim 1, wherein the simulated event includes displaying within the virtual environment at least one digital twin representing a person, the at least one item, a pre-event condition of the at least one item, an event condition of the at least one item, a post-event condition of the at least one item, or other objects involved in the simulated event.

11. The computer system of claim 1, wherein the at least one processor is further programmed to:
generate a visual representation of the simulated event based upon an event profile containing data associated with the simulated event;
input the event profile data, the sensor data and a geographic location of the event into an event model to generate the visual representation of a specific simulated event including the at least one item at the geographic location;
present the visual representation to the one or more user computer devices within the virtual environment; and
determine if the event represented by the simulated event is a covered loss.

12. A computer-implemented method for conducting interactions of a simulated event for a plurality of users in a virtual environment, the computer-implemented method performed by a computer system including at least one processor and at least one memory device in communication with the at least one processor and one or more user computer devices, the computer-implemented method comprising:
communicating, via the at least one processor, with the one or more user computer devices to cause the one or more user computer devices to present the virtual environment including at least one item of a first user associated with a first user device of the one or more user computer devices;
receiving, via the at least one processor, sensor data from one or more sensors associated with the first user device, the sensor data including data related to the at least one item;
selecting, via the at least one processor, a simulated event involving the at least one item based upon an input from the one or more user computer devices;
generating, via the at least one processor, the simulated event involving the at least one item and using the received sensor data for display within the virtual environment; and
displaying, via the at least one processor, the simulated event involving the at least one item to be displayed within the virtual environment to the first user using the first user device and at least a second user associated with a second user device of the one or more user computer devices, wherein the first user and the second user visually experience the simulated event involving the at least one item via the respective first user device and the second user device.

13. The computer-implemented method of claim 12, further comprising:
building, via the at least one processor, a training dataset including a plurality of historical event records for a plurality of different events;
training using the training dataset, via the at least one processor, a first event model of a plurality of different event models using one or more machine learning and/or artificial intelligence techniques, wherein the first event model is trained to generate a first simulated event within the virtual environment; and
applying, via the at least one processor, at least one of: (i) the sensor data including image data of the at least one item, and (ii) input from the one or more user computer devices including a geographic location of the at least one item at a time when the simulated event occurs to the trained first event model to generate one or more model outputs for display within the virtual environment including a display of the first simulated event and an impact of the first simulated event on the at least one item.

14. The computer-implemented method of claim 12, further comprising determining, via the at least one processor, a damage to the at least one item in the event simulation, wherein determining the damage comprises processing item data associated with the at least one item and event data representing the simulated event to compute a pre-event condition of the at least one item and at least one impact to the at least one item during the simulated event and after the simulated event.

15. The computer-implemented method of claim 14, further comprising displaying, via the at least one processor, in the virtual environment on the one or more user computer devices, at least one impact to the at least one item due to the simulated event, the at least one impact displayed as an overlay upon the at least one item as viewed within the virtual environment such that the user is able to see the damage to the at least one item due to the event.

16. The computer-implemented method of claim 15, further comprising:
enabling the first user to contact an agent through the virtual environment by selecting a contact prompt displayed within a display device of the first user device; and
causing a response prompt to be displayed within the virtual environment, enabling the agent using an agent device of the one or more user computer devices to communicate with the first user within the virtual environment,
wherein the agent appears within the virtual environment as an avatar controlled by a replicant persona selectable by the first user.

17. The computer-implemented method of claim 12, wherein displaying the virtual environment further comprises displaying the virtual environment with sensory data as an output of the simulated event, the sensory data comprising: motion data, image data, audio data, haptic data, or olfactory data. cm 18. The computer-implemented method of claim 12, further comprising:
modifying, via the at least one processor, the virtual environment based upon the simulated event selected from a plurality of selectable simulated events, wherein each simulated event includes an event profile containing data associated with the corresponding simulated event; and
inputting the event profile for the selected simulated event into a corresponding event model along with the sensor data associated with the at least one item to output the modified virtual environment showing within the virtual environment: (i) a virtual representation of the at least one item, prior to the simulated event, (ii) a virtual representation of the at least one item during the simulated event, and (iii) a virtual representation of the at least one item after the simulated event.

19. At least one non-transitory computer-readable media having computer-executable instructions embodied thereon, wherein when executed by a computer system including at least one processor in communication with one or more user computer devices, the computer-executable instructions cause the at least one processor to:
communicate with the one or more user computer devices to cause the one or more user computer devices to present a virtual environment including at least one item of a first user associated with a first user device of the one or more user computer devices;
receive sensor data from one or more sensors associated with the first user device, the sensor data including data related to the at least one item;
select a simulated event involving the at least one item based upon an input from the one or more user computer devices;
generate the simulated event involving the at least one item and using the received sensor data for display within the virtual environment; and
cause the simulated event involving the at least one item to be displayed within the virtual environment to the first user using the first user device and at least a second user associated with a second user device of the one or more user computer devices, wherein the first user and the second user visually experience the simulated event involving the at least one item via the respective first user device and the second user device.

20. The at least one non-transitory computer-readable media of claim 19, wherein the computer-executable instructions further cause the at least one processor to:
build a training dataset including a plurality of historical event records for a plurality of different events;
train a first event model of a plurality of different event models, using one or more machine learning and/or artificial intelligence techniques, using the training dataset, wherein the first event model is trained to generate a first simulated event within the virtual environment; and
apply at least one of (i) the sensor data including image data of the at least one item, and (ii) input from the one or more user computer devices including a geographic location of the at least one item at a time when the simulated event occurs to the trained first event model to generate one or more model outputs for display within the virtual environment including a display of the first simulated event and an impact of the first simulated event on the at least one item.
